(19) United States
(12) Patent Application Publication
(10) Pub. No.: US 2026/0171009 A1
(43) Pub. Date: Jun. 18, 2026

(54) DISPLAY PANEL AND DISPLAY DEVICE

(71) Applicant: Xiamen Tianma Display Technology Co., Ltd., Xiamen (CN)

(72) Inventors: Jian KUANG, Xiamen (CN); Lei WANG, Xiamen (CN); Wenya ZHANG, Xiamen (CN)

(73) Assignee: Xiamen Tianma Display Technology Co., Ltd., Xiamen (CN)

(21) Appl. No.: 19/535,267

(22) Filed: Feb. 10, 2026

(30) Foreign Application Priority Data
Nov. 21, 2025 (CN) 202511724905.8

(51) Int. Cl. G09G 3/32

(52) U.S. Cl. CPC G09G 3/32; G09G 2300/043; G09G 2300/0819; G09G 2300/0852; G09G 2310/0286; G09G 2310/08; G09G 2320/0233; G09G 2330/021

(57) ABSTRACT

A display panel includes multiple pixel circuits and multiple light-emitting elements. A pixel circuit includes a drive unit, a light emission control unit, and a first energy storage unit. The light emission control unit includes a first light emission control subunit and a second light emission control subunit. The drive unit includes a drive transistor. The first light emission control subunit, the drive transistor, the second light emission control subunit, and a light-emitting element are sequentially connected in series between a first power signal terminal and a second power signal terminal. The first light emission control subunit includes a first transistor. The first energy storage unit includes a second transistor. A gate of the first transistor and a gate of the second transistor both receive the same first light emission control signal. The first transistor and the second transistor have different channel types.

### CROSS-REFERENCE TO RELATED APPLICATION(S)

This application claims priority to Chinese Patent Application No. 202511724905.8, filed on Nov. 21, 2025, the disclosure of which is incorporated herein by reference in its entirety.

### TECHNICAL FIELD

Embodiments of the present application relate to the technical field of display technology, and in particular, to a display panel and a display device.

### BACKGROUND

As display panels are gradually applied in various aspects of daily life, users' requirements for display performance are becoming increasingly higher. In current mainstream display panel products, the display panel is generally disposed with a large number of driving signal lines due to performance demands such as display resolution, refresh rate, and multi-zone light control. These driving signals include not only core signals for pixel switch control and grayscale level adjustment, but also auxiliary signals for timing synchronization and voltage calibration, resulting in increasingly complex overall driving logic and implementation.

To meet independent driving requirements for different regions, panels often need to be configured with multiple groups of mutually non-interfering GOA (Gate Driver on Array) driving signals. These independent GOA signal modules and their associated wiring space substantially occupy the bezel area of the display panel, ultimately making it difficult to further narrow the bezel of the product and restricting the development of display panels toward a higher screen-to-body ratio.

### SUMMARY

Embodiments of the present application provide a display panel and a display device.

In a first aspect, embodiments of the present application provide a display panel.

The display panel includes multiple pixel circuits and multiple light-emitting elements.

A pixel circuit includes a drive unit, a light emission control unit, and a first energy storage unit.

The light emission control unit includes a first light emission control subunit and a second light emission control subunit. The drive unit includes a drive transistor. The first light emission control subunit, the drive transistor, the second light emission control subunit, and a light-emitting element are sequentially connected in series between a first power signal terminal and a second power signal terminal.

The first light emission control subunit is electrically connected to a first terminal of the drive transistor. The first energy storage unit is connected between a first potential signal terminal and a second terminal of the drive transistor.

The first light emission control subunit includes a first transistor. The first energy storage unit includes an energy storage control subunit. The energy storage control subunit includes a second transistor.

A gate of the first transistor and a gate of the second transistor are both configured to receive the same first light emission control signal. The first transistor and the second transistor have different channel types.

In a second aspect, embodiments of the present application also provide a display device that includes the display panel as described in the first aspect.

### BRIEF DESCRIPTION OF DRAWINGS

FIG. 1 is a diagram illustrating an overall structure of a display panel according to an embodiment of the present application.

FIG. 2 is a diagram illustrating a circuit structure of a display panel according to an embodiment of the present application.

FIG. 3 is a timing graph of a display panel according to an embodiment of the present application.

FIG. 4 is another diagram illustrating the circuit structure of a display panel according to an embodiment of the present application.

FIG. 5 is another diagram illustrating the overall structure of a display panel according to an embodiment of the present application.

FIG. 6 is yet another diagram illustrating the circuit structure of a display panel according to an embodiment of the present application.

FIG. 7 is yet another diagram illustrating the overall structure of a display panel according to an embodiment of the present application.

FIG. 8 is yet another diagram illustrating the circuit structure of a display panel according to an embodiment of the present application.

FIG. 9 is another timing graph of a display panel according to an embodiment of the present application.

FIG. 10 is yet another diagram illustrating the overall structure of a display panel according to an embodiment of the present application.

FIG. 11 is yet another diagram illustrating the circuit structure of a display panel according to an embodiment of the present application.

FIG. 12 is yet another diagram illustrating the overall structure of a display panel according to an embodiment of the present application.

FIG. 13 is yet another timing graph of a display panel according to an embodiment of the present application.

FIG. 14 is yet another diagram illustrating the circuit structure of a display panel according to an embodiment of the present application.

FIG. 15 is yet another timing graph of a display panel according to an embodiment of the present application.

FIG. 16 is yet another diagram illustrating the overall structure of a display panel according to an embodiment of the present application.

FIG. 17 is yet another diagram illustrating the circuit structure of a display panel according to an embodiment of the present application.

FIG. 18 is yet another timing graph of a display panel according to an embodiment of the present application.

FIG. 19 is yet another diagram illustrating the overall structure of a display panel according to an embodiment of the present application.

FIG. 20 is yet another diagram illustrating the circuit structure of a display panel according to an embodiment of the present application.

FIG. 21 is yet another timing graph of a display panel according to an embodiment of the present application.

FIG. 22 is a diagram illustrating the structure of the display panel shown in FIG. 20 during a reset phase.

FIG. 23 is a diagram illustrating the structure of the display panel shown in FIG. 20 during a threshold compensation phase.

FIG. 24 is a diagram illustrating the structure of the display panel shown in FIG. 20 during a data writing phase.

FIG. 25 is a diagram illustrating the structure of the display panel shown in FIG. 20 during a light emission phase.

FIG. 26 is yet another diagram illustrating the circuit structure of a display panel according to an embodiment of the present application.

FIG. 27 is yet another timing graph of a display panel according to an embodiment of the present application.

FIG. 28 is a diagram illustrating the structure of a display device according to an embodiment of the present application.

### DETAILED DESCRIPTION

The solutions in the embodiments of the present application are described clearly and completely in conjunction with drawings in the embodiments of the present application from which the solutions are better understood by those skilled in the art. Apparently, the embodiments described below are part, not all, of the embodiments of the present application. Based on the embodiments described herein, all other embodiments acquired by those of ordinary skill in the art on the premise that no creative work is done are within the scope of the present application.

It is to be noted that terms such as “first” and “second” in the description, claims, and drawings of the present application are used to distinguish between similar objects and are not necessarily used to describe a particular order or sequence. It should be understood that the data used in this manner are interchangeable where appropriate so that the embodiments of the present application described herein may also be implemented in a sequence not illustrated or described herein. Additionally, terms “comprising”, “including”, and any other variations thereof are intended to encompass a non-exclusive inclusion. For example, a process, method, system, product, or device that includes a series of steps or units not only includes the expressly listed steps or units but may also include other steps or units that are not expressly listed or are inherent to such a process, method, product, or device.

Based on the technical problems in the background, embodiments of the present application provide a display panel. The display panel includes multiple pixel circuits and multiple light-emitting elements. A pixel circuit includes a drive unit, a light emission control unit, and a first energy storage unit. The light emission control unit includes a first light emission control subunit and a second light emission control subunit. The drive unit includes a drive transistor. The first light emission control subunit, the drive transistor, the second light emission control subunit, and a light-emitting element are sequentially connected in series between a first power signal terminal and a second power signal terminal. The first light emission control subunit is electrically connected to a first terminal of the drive transistor, and the first energy storage unit is connected between a first potential signal terminal and a second terminal of the drive transistor. The first light emission control subunit includes a first transistor. The first energy storage unit includes an energy storage control subunit, and the energy storage control subunit includes a second transistor. A gate of the first transistor and a gate of the second transistor both receive the same first light emission control signal. The first transistor and the second transistor have different channel types.

With the technical solution in the embodiments of the present application, in the display panel, a gate of a first transistor in the first light emission control subunit and a gate of a second transistor in the first energy storage unit both receive the same first light emission control signal. That is, transistors and gate control signals do not need to be arranged in a one-to-one correspondence. With this configuration, while the compensation function is achieved, the number of driving signals in the pixel circuits is appropriately reduced, the number of signal groups required to drive the pixel circuits is decreased, and the number of corresponding shift registers used is correspondingly reduced, thereby saving peripheral driving bezel space, facilitating a narrow bezel design, and satisfying driving requirements while achieving a higher driving frequency and a higher display image quality. Furthermore, since the first transistor and the second transistor have different channel types, while the gates of the first transistor and the second transistor receive the corresponding first light emission control signal, their turn-on or turn-off states are opposite. That is, the driving signal control processes for the first transistor and the second transistor are mutually independent and do not affect each other, thereby improving the situation in current pixel circuits where structures are relatively complex and occupy more bezel space, and reducing the complexity of the driving method for the pixel circuits.

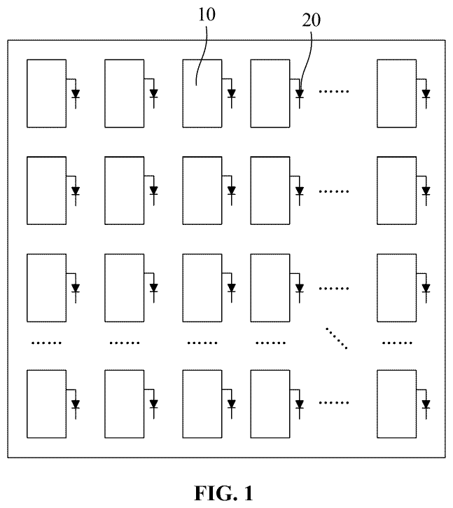

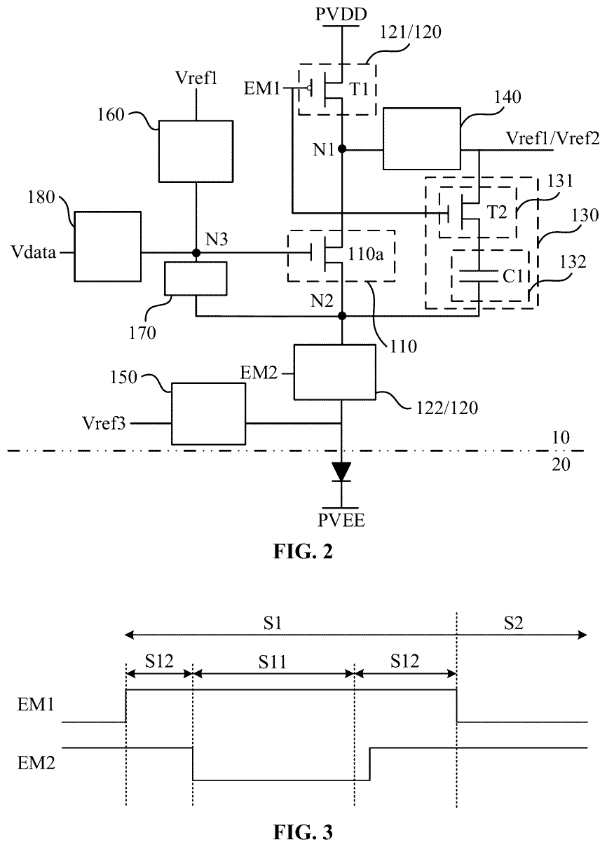

FIG. 1 is a diagram illustrating an overall structure of a display panel according to an embodiment of the present application. FIG. 2 is a diagram illustrating a circuit structure of a display panel according to an embodiment of the present application. As shown in FIG. 1 and FIG. 2, the display panel includes multiple pixel circuits 10 and multiple light-emitting elements 20. A pixel circuit 10 includes a drive unit 110, a light emission control unit 120, and a first energy storage unit 130. The light emission control unit 120 includes a first light emission control subunit 121 and a second light emission control subunit 122. The drive unit 110 includes a drive transistor 110a. The first light emission control subunit 121, the drive transistor 110a, the second light emission control subunit 122, and a light-emitting element 20 are sequentially connected in series between a first power signal terminal PVDD and a second power signal terminal PVEE. The first light emission control subunit 121 is electrically connected to a first terminal of the drive transistor 110a. The first energy storage unit 130 is connected between a first potential signal terminal Vref1 and a second terminal of the drive transistor 110a. The first light emission control subunit 121 includes a first transistor T1. The first energy storage unit 130 includes an energy storage control subunit 131, and the energy storage control subunit 131 includes a second transistor T2. A gate of the first transistor T1 and a gate of the second transistor T2 are both configured to receive the same first light emission control signal EM1. The first transistor T1 and the second transistor T2 have different channel types.

In one or more embodiments, the display panel includes multiple pixel circuits 10 and multiple light-emitting elements 20. This embodiment imposes no specific requirements or special limitations on the number and correspondence of the pixel circuits 10 and the light-emitting elements 20. Illustratively, the pixel circuits 10 and the light-emitting elements 20 may be arranged in a one-to-one correspondence, that is, one pixel circuit 10 is electrically connected to a corresponding light-emitting element 20, thereby providing a driving signal to the corresponding light-emitting element 20 through the pixel circuit 10 to drive the corresponding light-emitting element 20 to emit light. Illustratively, the light-emitting elements 20 may be arranged in an array. In the following embodiments, an example where one pixel circuit 10 corresponds to one light-emitting element 20 in the display panel shown in FIG. 1 is used for illustration and description.

With continued reference to FIG. 2, the pixel circuit 10 includes the drive unit 110, and the drive unit 110 includes the drive transistor 110a. Illustratively, the drive transistor 110a may be an N-type channel transistor or a P-type channel transistor. This embodiment imposes no limitation thereon, and those skilled in the art may make reasonable settings as needed. The drive transistor 110a can drive a correspondingly connected light-emitting element 20 to emit light. The pixel circuit 10 also includes a light emission control unit 120, and the light emission control unit 120 includes a first light emission control subunit 121 and a second light emission control subunit 122. Illustratively, a control terminal of the first light emission control subunit 121 may be electrically connected to a first light emission control signal EM1, thereby controlling the turn-on and turn-off of the first light emission control subunit 121 through the first light emission control signal EM1. Furthermore, a control terminal of the second light emission control subunit 122 may be electrically connected to a second light emission control signal EM2, thereby controlling the turn-on and turn-off of the second light emission control subunit 122 through the second light emission control signal EM2. The first light emission control subunit 121 includes a first transistor T1. Illustratively, the first transistor T1 may be an N-type channel transistor or a P-type channel transistor. This embodiment imposes no limitation thereon, and those skilled in the art may make reasonable settings as needed.

The display panel also includes the first power signal terminal PVDD and the second power signal terminal PVEE. The first power signal terminal PVDD may be a positive power signal terminal. The second power signal terminal PVEE may be a negative power signal terminal. The first light emission control subunit 121, the drive transistor 110a, the second light emission control subunit 122, and the light-emitting element 20 are sequentially connected in series between the first power signal terminal PVDD and the second power signal terminal PVEE. The first light emission control subunit 121 is electrically connected to a first terminal of the drive transistor 110a. The second light emission control subunit 122 is electrically connected to a second terminal of the drive transistor 110a. The second light emission control subunit 122 is disposed between the drive transistor 110a and the light-emitting element 20. Illustratively, a connection node between the first light emission control subunit 121 and the drive transistor 110a may be a first node N1, and a connection node between the second light emission control subunit 122 and the drive transistor 110a may be a second node N2. That is, under the action of the first power signal terminal PVDD, the drive unit 110 can control the current or voltage flowing through the light-emitting element 20 according to a data signal input to a gate of the drive transistor 110a, thereby controlling light emission brightness of the light-emitting element 20 and achieving different grayscale displays of the display panel. Furthermore, the series circuit between the first power signal terminal PVDD and the second power signal terminal PVEE can be controlled to be conducted in a specified time period according to a control signal transmitted to the control terminal of the first light emission control subunit 121 from the first light emission control signal EM1 and a control signal transmitted to the control terminal of the second light emission control subunit 122 from the second light emission control signal EM2, thereby allowing a drive current of the drive transistor 110a to flow into the light-emitting element 20. That is, the first light emission control subunit 121 and the second light emission control subunit 122 can control a light emission duration of the light-emitting element 20 and ensure that the light-emitting element 20 emits light at a correct timing. In a more easily understandable manner, when the first light emission control subunit 121, the drive transistor 110a, and the second light emission control subunit 122 are all turned on, the drive current provided by the drive transistor 110a can flow into the light-emitting element 20, thereby enabling the light-emitting element 20 to emit light.

The pixel circuit 10 also includes a first energy storage unit 130. The first energy storage unit 130 is connected between the first potential signal terminal Vref1 and the second terminal of the drive transistor 110a. That is, it may be understood that the first energy storage unit 130 is connected between the first potential signal terminal Vref1 and the second node N2. The first energy storage unit 130 includes an energy storage control subunit 131, and the energy storage control subunit 131 includes a second transistor T2. Illustratively, the second transistor T2 may be an N-type channel transistor or a P-type channel transistor. This embodiment imposes no limitation thereon, and those skilled in the art may make reasonable settings as needed. To address the problem in the related art where a large number of driving signals lead to excessive occupancy of the bezel space, a gate of the first transistor T1 in the first light emission control subunit 121 and a gate of the second transistor T2 in the first energy storage unit 130 in this embodiment are both configured to receive the same first light emission control signal EM1. That is, the turn-on and turn-off of the first transistor T1 and the second transistor T2 can be controlled using the first light emission control signal EM1, and thus it is not required to provide corresponding control signals for both the first transistor T1 and the second transistor T2 respectively. While the normal operation of the first transistor T1 and the second transistor T2 is ensured, the number of driving signals in the pixel circuits is appropriately reduced, the number of signal groups required to drive the pixel circuits is decreased, and the peripheral driving bezel space is saved, thereby facilitating a narrow bezel design. Furthermore, in this embodiment, the first transistor T1 and the second transistor T2 are configured to have different channel types so that while the first transistor T1 and the second transistor T2 receive the corresponding first light emission control signal EM1, their turn-on or turn-off states are different. For example, when the first light emission control signal EM1 is a high-level signal, the first transistor T1 is turned off under the control of the high-level signal, and the second transistor T2 is turned on under the control of the high-level signal. When the first light emission control signal EM1 is a low-level signal, the first transistor T1 is turned on under the control of the low-level signal, and the second transistor T2 is turned off under the control of the low-level signal. In this manner, it can be ensured that the first transistor T1 and the second transistor T2 are mutually independent and do not affect each other during the control by the first light emission control signal EM1, the compensation function can be achieved, and a higher driving frequency and a higher display image quality are achieved while driving requirements are satisfied.

In one or more embodiments, FIG. 3 is a timing graph of a display panel according to an embodiment of the present application. As shown in FIG. 2 and FIG. 3, a driving process of the pixel circuit 10 includes a non-light emission phase S1 and a light emission phase S2. The pixel circuit 10 is configured such that under the control of the first light emission control signal EM1, the first transistor T1 is turned off and the second transistor T2 is turned on in the non-light emission phase S1, and the first transistor T1 is turned on and the second transistor T2 is turned off in the light emission phase S2.

In one or more embodiments, the driving process of the pixel circuit 10 includes a non-light emission phase S1 and a light emission phase S2, and the non-light emission phase S1 and the light emission phase S2 are executed alternately. In the non-light emission phase S1, the light-emitting element 20 changes from a light-emitting state to a non-light-emitting state. The non-light emission phase S1 may include, but is not limited to, a reset process, a threshold compensation process, and a data writing process, so as to ensure normal light emission of the light-emitting element 20 in the next light emission phase S2. In the non-light emission phase S1, the second transistor T2 may be turned on under the control of the first light emission control signal EM1 so that the potential at the second terminal of the drive transistor 110a (that is, at the second node N2) satisfies the condition for subsequently illuminating the light-emitting element 20. Moreover, the first transistor T1 may be turned off under the control of the first light emission control signal EM1. In this case, signal transmitted from the first power signal terminal PVDD is not required, thereby effectively reducing the power consumption of the display panel. Furthermore, in the light emission phase S2, the light-emitting element 20 changes from a non-light-emitting state to a light-emitting state, that is, the light emission phase S2 is a lighting process of the light-emitting element 20. In the light emission phase S2, the first transistor T1 may be turned on under the control of the first light emission control signal EM1 so that a series circuit between the first power signal terminal PVDD and the second power signal terminal PVEE is conducted, a drive current of the drive transistor 110a flows into the light-emitting element 20, and the light-emitting element 20 emits light. Moreover, the second transistor T2 may be turned off under the control of the first light emission control signal EM1. In this case, regulation of the potential at the second terminal of the drive transistor 110a (that is, at the second node N2) is not required, thereby effectively reducing the power consumption of the display panel.

In one or more embodiments, with continued reference to FIG. 2 and FIG. 3, the first transistor T1 is a P-type channel transistor, and the second transistor T2 is an N-type channel transistor. The control process of the first light emission control signal EM1 will be illustratively described below according to the specific channel types of the first transistor T1 and the second transistor T2.

In one or more embodiments, in the non-light emission phase S1, the first light emission control signal EM1 is a high-level signal. Then, under the control of the first light emission control signal EM1, the gate of the first transistor T1 receives an inactive level signal, and the first transistor T1 is correspondingly turned off, while the gate of the second transistor T2 receives an active level signal, and the second transistor T2 is correspondingly turned on so that a potential signal provided by the first potential signal terminal Vref1 can be written to the second node N2 through the second transistor T2. In the light emission phase S2, the first light emission control signal EM1 is a low-level signal. Then, under the control of the first light emission control signal EM1, the gate of the first transistor T1 receives an active level signal, and the first transistor T1 is correspondingly turned on, while the gate of the second transistor T2 receives an inactive level signal, and the second transistor T2 is correspondingly turned off so that a power signal provided by the first power signal terminal PVDD can be transmitted to the drive transistor 110a and the light-emitting element 20 through the first transistor T1, thereby ensuring normal light emission of the light-emitting element 20.

In one or more embodiments, with continued reference to FIG. 2, the first energy storage unit 130 also includes an energy storage subunit 132. The energy storage control subunit 131 and the energy storage subunit 132 are sequentially connected in series between the first potential signal terminal Vref1 and the second terminal of the drive transistor 110a.

In one or more embodiments, the first energy storage unit 130 includes an energy storage control subunit 131 and an energy storage subunit 132. A first terminal of the energy storage control subunit 131 is electrically connected to the first potential signal terminal Vref1, a second terminal of the energy storage control subunit 131 is electrically connected to a first terminal of the energy storage subunit 132, and a second terminal of the energy storage subunit 132 is electrically connected to the second terminal of the drive transistor 110a. That is, the energy storage control subunit 131 and the energy storage subunit 132 are sequentially connected in series between the first potential signal terminal Vref1 and the second terminal of the drive transistor 110a. In a specific embodiment, two terminals of the first transistor T1 are electrically connected to the first power signal terminal PVDD and the first terminal of the drive transistor 110a, respectively; the energy storage subunit 132 includes a first capacitor C1; a first terminal of the second transistor T2 is electrically connected to the first potential signal terminal Vref1, a second terminal of the second transistor T2 is electrically connected to a first plate of the first capacitor C1, and a second plate of the first capacitor C1 is electrically connected to the second terminal of the drive transistor 110a.

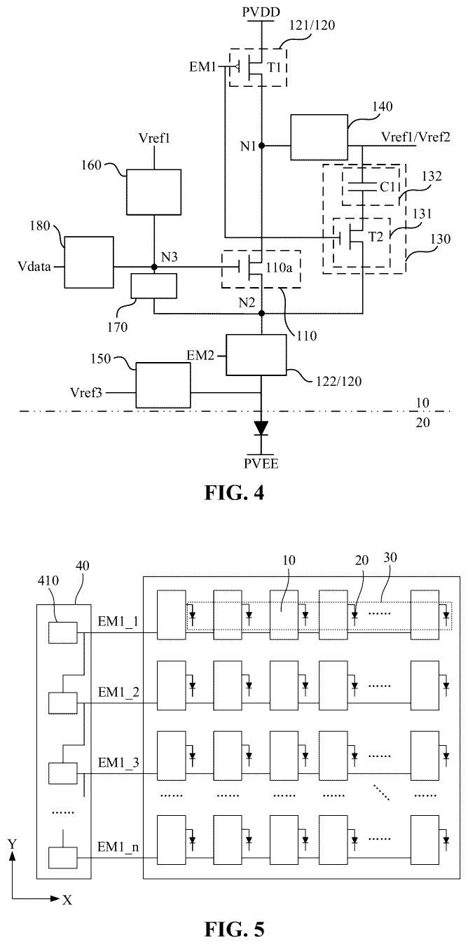

Alternatively, FIG. 4 is another diagram illustrating the circuit structure of a display panel according to an embodiment of the present application. As shown in FIG. 4, the first energy storage unit 130 also includes an energy storage subunit 132; the energy storage control subunit 131 and the energy storage subunit 132 are sequentially connected in series between the second terminal of the drive transistor 110a and the first potential signal terminal Vref1.

In one or more embodiments, the first energy storage unit 130 includes an energy storage control subunit 131 and an energy storage subunit 132. A first terminal of the energy storage control subunit 131 is electrically connected to the second terminal of the drive transistor 110a, a second terminal of the energy storage control subunit 131 is electrically connected to a first terminal of the energy storage subunit 132, and a second terminal of the energy storage subunit 132 is electrically connected to the first potential signal terminal Vref1. That is, the energy storage control subunit 131 and the energy storage subunit 132 are sequentially connected in series between the second terminal of the drive transistor 110a and the first potential signal terminal Vref1. In a specific embodiment, two terminals of the first transistor T1 are electrically connected to the first power signal terminal PVDD and the first terminal of the drive transistor 110a, respectively; the energy storage subunit 132 includes a first capacitor C1; a first terminal of the second transistor T2 is electrically connected to the second terminal of the drive transistor 110a, a second terminal of the second transistor T2 is electrically connected to a first plate of the first capacitor C1, and a second plate of the first capacitor C1 is electrically connected to the first potential signal terminal Vref1.

In one or more embodiments, FIG. 5 is another diagram illustrating the overall structure of a display panel according to an embodiment of the present application. As shown in FIG. 5, multiple light-emitting elements 20 are arranged in an array along a first direction X and a second direction Y; multiple light-emitting elements 20 arranged along the first direction X form a light-emitting element group 30, and multiple light-emitting element groups 30 are arranged along the second direction Y; the display panel also includes a first shift register circuit 40, and the first shift register circuit 40 includes multiple cascaded first shift register units 410; a first shift register unit 410 is configured to output the first light emission control signal EM1 to the pixel circuits 10 connected to the same light-emitting element group 30.

In one or more embodiments, the display panel also includes a first shift register circuit 40, and the first shift register circuit 40 includes multiple cascaded first shift register units 410. Each first shift register unit 410 corresponds to one light-emitting element group 30, and each first shift register unit 410 outputs the same first light emission control signal EM1 to the pixel circuits 10 connected to all light-emitting elements 20 in the corresponding light-emitting element group 30. That is, the first shift register circuit 40 provides a uniform first light emission control signal EM1 to a group of light-emitting elements 20 in the same row or the same column through the cascaded first shift register units 410. On this basis, since the gate of the first transistor T1 and the gate of the second transistor T2 both receive the same first light emission control signal EM1, the number of control signals used can be reduced, thereby reducing the number of corresponding shift register units used, further saving peripheral driving bezel space, and facilitating a narrow bezel design.

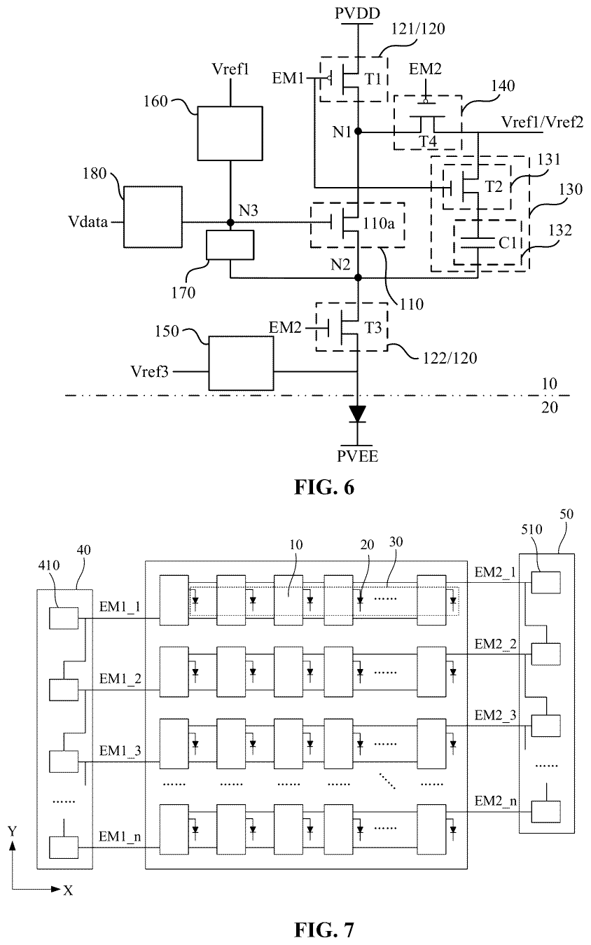

In one or more embodiments, FIG. 6 is yet another diagram illustrating the circuit structure of a display panel according to an embodiment of the present application. As shown in FIG. 6, the second light emission control subunit 122 includes a third transistor T3, and two terminals of the third transistor T3 are electrically connected to the second terminal of the drive transistor 110a and an anode of the light-emitting element 20, respectively; the pixel circuit 10 also includes a compensation control unit 140, the compensation control unit 140 includes a fourth transistor T4, and two terminals of the fourth transistor T4 are electrically connected to a second potential signal terminal Vref2 and the first terminal of the drive transistor 110a, respectively; a gate of the third transistor T3 and a gate of the fourth transistor T4 are both configured to receive the same second light emission control signal EM2, and the third transistor T3 and the fourth transistor T4 have different channel types.

In one or more embodiments, the second light emission control subunit 122 includes a third transistor T3. Illustratively, the third transistor T3 may be an N-type channel transistor or a P-type channel transistor. This embodiment imposes no limitation thereon, and those skilled in the art may make reasonable settings as needed. The gate of the first transistor T1 in the first light emission control subunit 121 may be electrically connected to the first light emission control signal EM1, thereby controlling the turn-on and turn-off of the first transistor T1 through the first light emission control signal EM1. The gate of the third transistor T3 in the second light emission control subunit 122 may be electrically connected to the second light emission control signal EM2, thereby controlling the turn-on and turn-off of the third transistor T3 through the second light emission control signal EM2. The first transistor T1, the drive transistor 110a, the third transistor T3, and the light-emitting element 20 are sequentially connected in series between the first power signal terminal PVDD and the second power signal terminal PVEE. Two terminals of the first transistor T1 are electrically connected to the first power signal terminal PVDD and the first terminal of the drive transistor 110a, respectively, and two terminals of the third transistor T3 are electrically connected to the second terminal of the drive transistor 110a and the anode of the light-emitting element 20, respectively. In this manner, when the first transistor T1, the drive transistor 110a, and the third transistor T3 are all turned on, a drive current provided by the drive transistor 110a flows into the light-emitting element 20, thereby enabling the light-emitting element 20 to emit light.

The pixel circuit 10 also includes a compensation control unit 140, and the compensation control unit 140 includes a fourth transistor T4. Illustratively, the fourth transistor T4 may be an N-type channel transistor or a P-type channel transistor. This embodiment imposes no limitation thereon, and those skilled in the art may make reasonable settings as needed. Two terminals of the fourth transistor T4 are electrically connected to the second potential signal terminal Vref2 and the first terminal of the drive transistor 110a, respectively. That is, it can be understood that the compensation control unit 140 is connected between the second potential signal terminal Vref2 and the first node N1. To address the problem in the related art where a large number of driving signals lead to excessive occupancy of the bezel space, the gate of the third transistor T3 and the gate of the fourth transistor T4 in this embodiment are both configured to receive the same second light emission control signal EM2. That is, the turn-on and turn-off of the third transistor T3 and the fourth transistor T4 can be controlled using the second light emission control signal EM2, and thus it is not required to provide corresponding control signals for both the third transistor T3 and the fourth transistor T4. While the normal operation of the third transistor T3 and the fourth transistor T4 is ensured, the number of driving signals in the pixel circuits is appropriately reduced, the number of signal groups required to drive the pixel circuits is decreased, and peripheral driving bezel space is saved, thereby facilitating a narrow bezel design. Furthermore, in this embodiment, the third transistor T3 and the fourth transistor T4 are configured to have different channel types so that after the third transistor T3 and the fourth transistor T4 receive the corresponding second light emission control signal EM2, their turn-on or turn-off states are different. For example, when the second light emission control signal EM2 is a high-level signal, the third transistor T3 is turned on under the control of the high-level signal, and the fourth transistor T4 is turned off under the control of the high-level signal. When the second light emission control signal EM2 is a low-level signal, the third transistor T3 is turned off under the control of the low-level signal, and the fourth transistor T4 is turned on under the control of the low-level signal. In this manner, it can be ensured that the third transistor T3 and the fourth transistor T4 are mutually independent and do not affect each other during the control by the second light emission control signal EM2, the compensation function can be achieved, and a higher driving frequency and a higher display image quality are achieved while driving requirements are satisfied.

It should also be noted that two terminals of the fourth transistor T4 are electrically connected to the second potential signal terminal Vref2 and the first terminal of the drive transistor 110a, respectively. The arrangement of the fourth transistor T4 can facilitate the clamping of the potential at the first terminal of the drive transistor 110a, thereby changing the potential at the second terminal of the corresponding drive transistor 110a. To further reduce the number of signal lines corresponding to the pixel circuit 10, in one or more embodiments, the first potential signal terminal Vref1 or the first power signal terminal PVDD may be reused as the second potential signal terminal Vref2. That is, the second potential signal terminal Vref2 does not need to be configured, and two terminals of the fourth transistor T4 are electrically connected to the first potential signal terminal Vref1 and the first terminal of the drive transistor 110a, respectively, or two terminals of the fourth transistor T4 are electrically connected to the first power signal terminal PVDD and the first terminal of the drive transistor 110a, respectively. FIG. 6 illustrates that the first potential signal terminal Vref1 is reused as the second potential signal terminal Vref2, but imposes no limitation thereon. In other embodiments, the first power signal terminal PVDD may be reused as the second potential signal terminal Vref2, and the second potential signal terminal Vref2 may also be an additionally arranged potential signal terminal. Those skilled in the art may make reasonable settings as needed.

In one or more embodiments, with continued reference to FIG. 3 and FIG. 6, a driving process of the pixel circuit 10 includes a non-light emission phase S1 and a light emission phase S2, the non-light emission phase S1 includes a threshold compensation phase S11, and the pixel circuit 10 is also configured such that under the control of the second light emission control signal EM2, the fourth transistor T4 is turned on and the third transistor T3 is turned off in the threshold compensation phase S11, and the fourth transistor T4 is turned off and the third transistor T3 is turned on in the light emission phase S2.

In one or more embodiments, the driving process of the pixel circuit 10 includes a non-light emission phase S1 and a light emission phase S2, and the non-light emission phase S1 and the light emission phase S2 are executed alternately. The non-light emission phase S1 includes a threshold compensation phase S11. In the threshold compensation phase S11, the fourth transistor T4 may be turned on under the control of the second light emission control signal EM2 so that the potential difference between the first terminal of the drive transistor 110a (that is, at the first node N1) and the second terminal of the drive transistor 110a (that is, at the second node N2) is clamped at a preset threshold voltage Vth, satisfying the condition for subsequently illuminating the light-emitting element 20. Moreover, the third transistor T3 may be turned off under the control of the second light emission control signal EM2. In this case, transmission of a drive current of the drive transistor 110a is not required, thereby effectively reducing the power consumption of the display panel. Furthermore, in the light emission phase S2, the third transistor T3 may be turned on under the control of the second light emission control signal EM2 so that the series circuit between the first power signal terminal PVDD and the second power signal terminal PVEE is conducted, a drive current of the drive transistor 110a flows into the light-emitting element 20, and the light-emitting element 20 emits light. Moreover, the fourth transistor T4 may be turned off under the control of the second light emission control signal EM2. In this case, clamping of the potential at the first terminal of the drive transistor 110a (that is, at the first node N1) is not required, thereby effectively reducing the power consumption of the display panel.

In one or more embodiments, with continued reference to FIG. 3 and FIG. 6, the non-light emission phase S1 also includes a non-threshold compensation phase S12, and the pixel circuit 10 is also configured such that under the control of the second light emission control signal EM2, the fourth transistor T4 is turned off and the third transistor T3 is turned on in the non-threshold compensation phase S12.

In one or more embodiments, the non-light emission phase S1 also includes a non-threshold compensation phase S12, and the threshold compensation phase S11 and the non-threshold compensation phase S12 do not overlap with each other. In the non-threshold compensation phase S12, the third transistor T3 may be turned on under the control of the second light emission control signal EM2 so that the potential at the second terminal of the drive transistor 110a (that is, at the second node N2) is reset, or data is written to the potential at the second terminal of the drive transistor 110a (that is, at the second node N2), satisfying the condition for subsequently illuminating the light-emitting element 20. Moreover, the fourth transistor T4 may be turned off under the control of the second light emission control signal EM2. In this case, clamping of the potential at the first terminal of the drive transistor 110a (that is, at the first node N1) is not required, thereby effectively reducing the power consumption of the display panel.

In one or more embodiments, with continued reference to FIG. 3 and FIG. 6, the third transistor T3 is an N-type channel transistor, the fourth transistor T4 is a P-type channel transistor, and the drive transistor 110a is an N-type channel transistor. The control process of the second light emission control signal EM2 will be illustratively described below according to the specific channel types of the third transistor T3, the fourth transistor T4, and the drive transistor 110a.

Illustratively, in the threshold compensation phase S11, the second light emission control signal EM2 is a low-level signal. Then, under the control of the second light emission control signal EM2, the gate of the third transistor T3 receives an inactive level signal, and the third transistor T3 is correspondingly turned off, while the gate of the fourth transistor T4 receives an active level signal, and the fourth transistor T4 is correspondingly turned on. In this manner, a potential signal provided by the second potential signal terminal Vref2 can be written to the first node N1 through the fourth transistor T4. In the non-threshold compensation phase S12, the second light emission control signal EM2 is a high-level signal. Then, under the control of the second light emission control signal EM2, the gate of the third transistor T3 receives an active level signal, and the third transistor T3 is correspondingly turned on, while the gate of the fourth transistor T4 receives an inactive level signal, and the fourth transistor T4 is correspondingly turned off. In this case, regulation of the potential at the second node N2 is not required. In the light emission phase S2, the second light emission control signal EM2 is a high-level signal. Then, under the control of the second light emission control signal EM2, the gate of the third transistor T3 receives an active level signal, and the third transistor T3 is correspondingly turned on, while the gate of the fourth transistor T4 receives an inactive level signal, and the fourth transistor T4 is correspondingly turned off so that a power signal provided by the first power signal terminal PVDD can be transmitted to the drive transistor 110a and the light-emitting element 20 through the first transistor T1, thereby ensuring normal light emission of the light-emitting element 20.

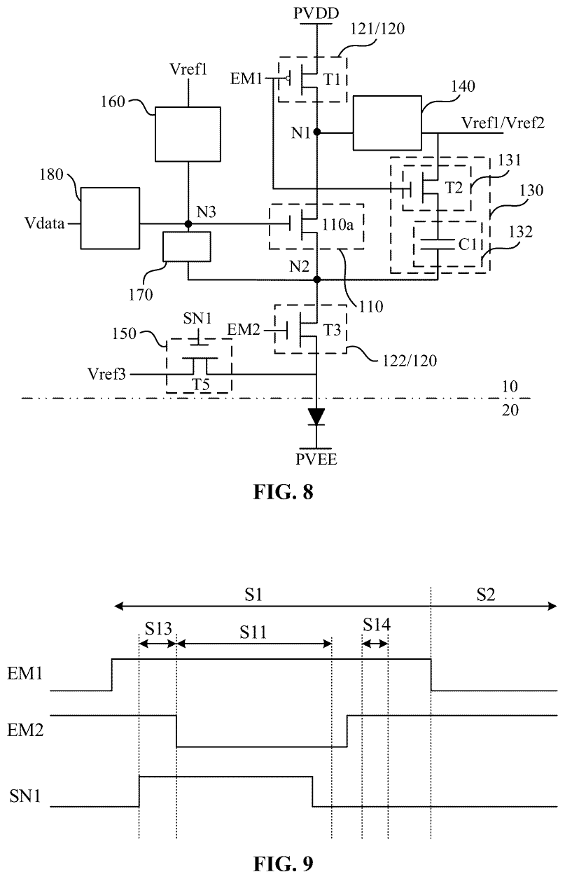

In one or more embodiments, FIG. 7 is yet another diagram illustrating the overall structure of a display panel according to an embodiment of the present application. As shown in FIG. 7, multiple light-emitting elements 20 are arranged in an array along a first direction X and a second direction Y; multiple light-emitting elements 20 arranged along the first direction X form a light-emitting element group 30, and multiple light-emitting element groups 30 are arranged along the second direction Y; the display panel also includes a second shift register circuit 50, and the second shift register circuit 50 includes multiple cascaded second register units 510; a second shift register unit 510 is configured to output the second light emission control signal EM2 to the pixel circuits 10 connected to the same light-emitting element group 30.

In one or more embodiments, the display panel also includes a second shift register circuit 50, and the second shift register circuit 50 includes multiple cascaded second shift register units 510. Each second shift register unit 510 corresponds to one light-emitting element group 30, and each second shift register unit 510 outputs the same second light emission control signal EM2 to the pixel circuits 10 connected to all light-emitting elements 20 in the corresponding light-emitting element group 30. That is, the second shift register circuit 50 provides a uniform second light emission control signal EM2 to a group of light-emitting elements 20 in the same row or the same column through the cascaded second shift register units 510. On this basis, since the gate of the third transistor T3 and the gate of the fourth transistor T4 both receive the same second light emission control signal EM2, the number of control signals used can be reduced, thereby reducing the number of corresponding shift register units used, further saving peripheral driving bezel space, and facilitating a narrow bezel design.

It should also be noted that the display panel shown in FIG. 7 includes both a first shift register circuit 40 and a second shift register circuit 50. The relative positions of the first shift register circuit 40 and the second shift register circuit 50 are exemplary, and no limitation is imposed thereon. Illustratively, the first shift register circuit 40 and the second shift register circuit 50 may be located on the same side of each light-emitting element group 30 (for example, both on a left side or both on a right side). The first shift register circuit 40 and the second shift register circuit 50 may also be located on two opposite sides of each light-emitting element group 30 (for example, one on the left and one on the right, or one on the top and one on the bottom). The first shift register circuit 40 and the second shift register circuit 50 may also be located on two adjacent sides of each light-emitting element group 30 (for example, one on the left and one on the top, or one on the right and one on the bottom). Those skilled in the art may make reasonable settings as needed.

In one or more embodiments, FIG. 8 is yet another diagram illustrating the circuit structure of a display panel according to an embodiment of the present application. As shown in FIG. 8, the second light emission control subunit 122 includes a third transistor T3, and two terminals of the third transistor T3 are electrically connected to the second terminal of the drive transistor 110a and an anode of the light-emitting element 20, respectively; the pixel circuit 10 also includes an anode reset unit 150, the anode reset unit 150 includes a fifth transistor T5, and two terminals of the fifth transistor T5 are electrically connected to a third potential signal terminal Vref3 and the anode of the light-emitting element 20, respectively; a gate of the third transistor T3 is configured to receive a second light emission control signal EM2, a gate of the fifth transistor T5 is configured to receive a first scan signal SN1, and the third transistor T3 and the fifth transistor T5 have the same channel type.

In one or more embodiments, the related content of the second light emission control subunit 122 and the third transistor T3 may refer to the preceding embodiments and will not be repeated in this embodiment. The pixel circuit 10 also includes an anode reset unit 150, and the anode reset unit 150 includes a fifth transistor T5. Illustratively, the fifth transistor T5 may be an N-type channel transistor or a P-type channel transistor. This embodiment imposes no limitation thereon, and those skilled in the art may make reasonable settings as needed. Two terminals of the fifth transistor T5 are electrically connected to the third potential signal terminal Vref3 and the anode of the light-emitting element 20, respectively. That is, it can be understood that the anode reset unit 150 is connected between the third potential signal terminal Vref3 and the second node N2. In a more easily understandable manner, a first terminal of the fifth transistor T5 is electrically connected to the third potential signal terminal Vref3, a second terminal of the fifth transistor T5 is electrically connected to the anode of the light-emitting element 20, and a control terminal/gate of the fifth transistor T5 is electrically connected to the first scan signal SN1, thereby enabling the anode reset unit 150 to be turned on under the control of the first scan signal SN1. Thus, a reset signal provided by the third potential signal terminal Vref3 can be written to the anode of the light-emitting element 20. Furthermore, a first terminal of the third transistor T3 is electrically connected to the second terminal of the drive transistor 110a, a second terminal of the third transistor T3 is electrically connected to the anode of the light-emitting element 20, and a control terminal/gate of the third transistor T3 is electrically connected to the second light emission control signal EM2, thereby enabling the second light emission control subunit 122 to be turned on under the control of the second light emission control signal EM2. Thus, a reset signal provided by the third potential signal terminal Vref3 can also be written to the second node N2. Furthermore, in this embodiment, the third transistor T3 and the fifth transistor T5 are configured to have the same channel type so that functional complementarity can be achieved through differences in the turn-on or turn-off of the third transistor T3 and the fifth transistor T5, thereby simplifying the circuit design and optimizing performance.

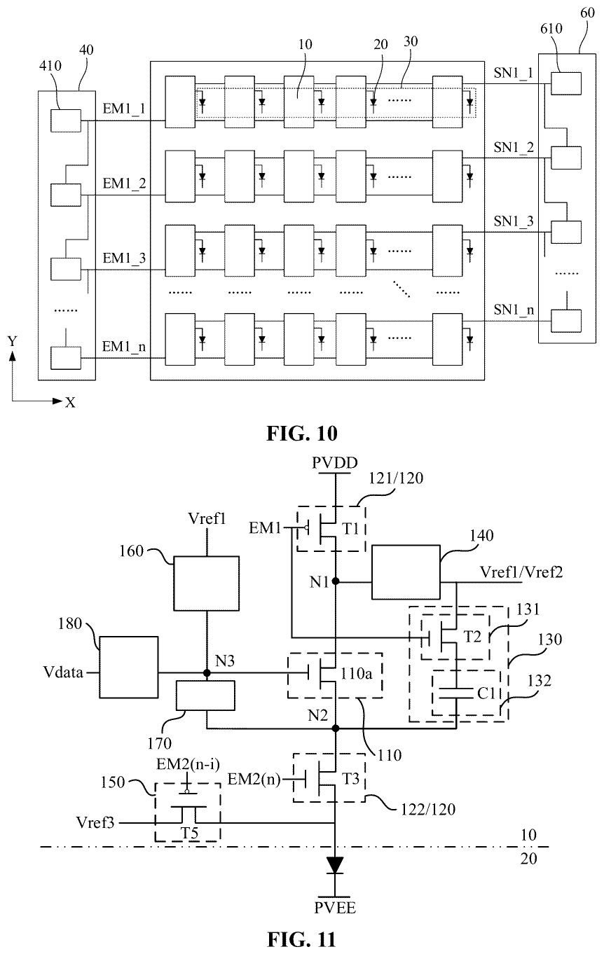

In one or more embodiments, FIG. 9 is another timing graph of a display panel according to an embodiment of the present application. As shown in FIG. 8 and FIG. 9, a driving process of the pixel circuit 10 includes a non-light emission phase S1 and a light emission phase S2, the non-light emission phase S1 includes a reset phase S13, and the pixel circuit 10 is also configured such that under the control of the first scan signal SN1, the fifth transistor T5 is turned on in the reset phase S13, and the fifth transistor T5 is turned off in the light emission phase S2.

In one or more embodiments, the driving process of the pixel circuit 10 includes a non-light emission phase S1 and a light emission phase S2, and the non-light emission phase S1 and the light emission phase S2 are executed alternately. The non-light emission phase S1 includes a reset phase S13. In the reset phase S13, the fifth transistor T5 may be turned on under the control of the first scan signal SN1 so that a reset signal provided by the third potential signal terminal Vref3 can be written to the anode of the light-emitting element 20, thereby resetting the anode of the light-emitting element 20. In the light emission phase S2, the fifth transistor T5 may be turned off under the control of the first scan signal SN1. In this case, the resetting of the anode of the light-emitting element 20 is not required, thereby effectively reducing the power consumption of the display panel.

In one or more embodiments, with continued reference to FIG. 8 and FIG. 9, the non-light emission phase S1 also includes a threshold compensation phase S11 and a data writing phase S14, and the pixel circuit 10 is also configured such that under the control of the first scan signal SN1, the fifth transistor T5 is turned on in the threshold compensation phase S11, and the fifth transistor T5 is turned off in the data writing phase S14.

In one or more embodiments, the non-light emission phase S1 includes a reset phase S13, a threshold compensation phase S11, and a data writing phase S14. In time sequence, the reset phase S13, the threshold compensation phase S11, and the data writing phase S14 are executed sequentially. In the threshold compensation phase S11, the fifth transistor T5 may be turned on under the control of the first scan signal SN1 so that a reset signal provided by the third potential signal terminal Vref3 can be written to the second node N2 through the fifth transistor T5 and the third transistor T3, thereby causing the potential at the second terminal of the drive transistor 110a (that is, at the second node N2) to satisfy the condition for subsequently illuminating the light-emitting element 20. In the data writing phase S14, the fifth transistor T5 may be turned off under the control of the first scan signal SN1. In this case, the resetting of the anode of the light-emitting element 20 is not required, thereby effectively reducing the power consumption of the display panel.

In one or more embodiments, with continued reference to FIG. 8 and FIG. 9, the third transistor T3 and the fifth transistor T5 are both N-type channel transistors. The control processes of the second light emission control signal EM2 and the first scan signal SN1 will be illustratively described below according to the specific channel types of the third transistor T3 and the fifth transistor T5.

Illustratively, in the reset phase S13, the second light emission control signal EM2 is a high-level signal. Then, under the control of the second light emission control signal EM2, the gate of the third transistor T3 receives an active level signal, and the third transistor T3 is correspondingly turned on. The first scan signal SN1 is a high-level signal. Then, under the control of the first scan signal SN1, the fifth transistor T5 is correspondingly turned on so that a potential signal provided by the third potential signal terminal Vref3 can be written to the anode of the light-emitting element 20 through the fifth transistor T5, and the potential signal provided by the third potential signal terminal Vref3 can be written to the second node N2 through the fifth transistor T5 and the third transistor T3. In the threshold compensation phase S11, the second light emission control signal EM2 is a low-level signal. Then, under the control of the second light emission control signal EM2, the gate of the third transistor T3 receives an inactive level signal, and the third transistor T3 is correspondingly turned off. The first scan signal SN1 is a high-level signal. Then, under the control of the first scan signal SN1, the fifth transistor T5 is correspondingly turned on so that the potential at the second terminal of the drive transistor 110a (that is, at the second node N2) satisfies the condition for subsequently illuminating the light-emitting element 20. In the data writing phase S14, the second light emission control signal EM2 is a high-level signal. Then, under the control of the second light emission control signal EM2, the gate of the third transistor T3 receives an active level signal, and the third transistor T3 is correspondingly turned on. The first scan signal SN1 is a low-level signal. Then, under the control of the first scan signal SN1, the fifth transistor T5 is correspondingly turned off, thereby further causing the potential at the second terminal of the drive transistor 110a (that is, at the second node N2) to satisfy the condition for subsequently illuminating the light-emitting element 20. In the light emission phase S2, the second light emission control signal EM2 is a high-level signal. Then, under the control of the second light emission control signal EM2, the gate of the third transistor T3 receives an active level signal, and the third transistor T3 is correspondingly turned on. The first scan signal SN1 is a low-level signal. Then, under the control of the first scan signal SN1, the fifth transistor T5 is correspondingly turned off so that a power signal provided by the first power signal terminal PVDD can be transmitted to the drive transistor 110a and the light-emitting element 20 through the first transistor T1, thereby ensuring normal light emission of the light-emitting element 20, and in this case, regulation of the potential at the second node N2 is not required.

In one or more embodiments, FIG. 10 is yet another diagram illustrating the overall structure of a display panel according to an embodiment of the present application. As shown in FIG. 10, multiple light-emitting elements 20 are arranged in an array along a first direction X and a second direction Y; multiple light-emitting elements 20 arranged along the first direction X form a light-emitting element group 30, and multiple light-emitting element groups 30 are arranged along the second direction Y; the display panel also includes a third shift register circuit 60, and the third shift register circuit 60 includes multiple cascaded third register units 610; a third shift register unit 610 is configured to output the first scan signal SN1 to the pixel circuits 10 connected to the same light-emitting element group 30.

In one or more embodiments, the display panel also includes a third shift register circuit 60, and the third shift register circuit 60 includes multiple cascaded third shift register units 610. Each third shift register unit 610 corresponds to one light-emitting element group 30, and each third shift register unit 610 outputs the same first scan signal SN1 to the pixel circuits 10 connected to all light-emitting elements 20 in the corresponding light-emitting element group 30. That is, the third shift register circuit 60 provides a uniform first scan signal SN1 to a group of light-emitting elements 20 in the same row or the same column through the cascaded third shift register units 610.

It should also be noted that the display panel shown in FIG. 10 includes both a first shift register circuit 40 and a third shift register circuit 60. The relative positions of the first shift register circuit 40 and the third shift register circuit 60 are exemplary, and no limitation is imposed thereon. Illustratively, the first shift register circuit 40 and the third shift register circuit 60 may be located on the same side of each light-emitting element group 30 (for example, both on a left side or both on a right side). The first shift register circuit 40 and the third shift register circuit 60 may also be located on two opposite sides of each light-emitting element group 30 (for example, one on the left and one on the right, or one on the top and one on the bottom). The first shift register circuit 40 and the third shift register circuit 60 may also be located on two adjacent sides of each light-emitting element group 30 (for example, one on the left and one on the top, or one on the right and one on the bottom). Those skilled in the art may make reasonable settings as needed. In addition, the display panel may include at least one of a first shift register circuit 40, a second shift register circuit 50, and a third shift register circuit 60. The display panel may also simultaneously include a first shift register circuit 40, a second shift register circuit 50, and a third shift register circuit 60. The specific positional relationships among the three may be reasonably set as needed, which is not illustrated one by one in this embodiment.

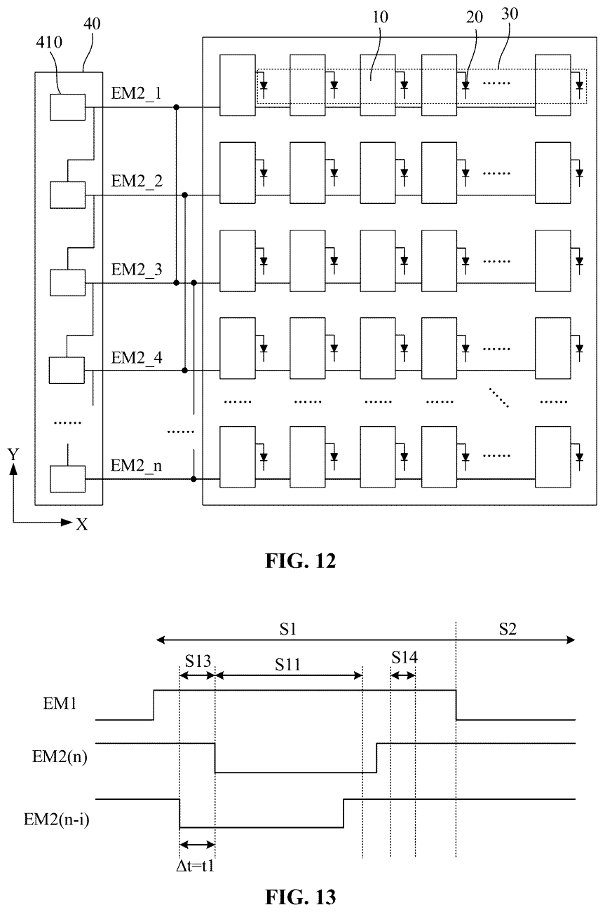

In one or more embodiments, FIG. 11 is yet another diagram illustrating the circuit structure of a display panel according to an embodiment of the present application, and FIG. 12 is yet another diagram illustrating the overall structure of a display panel according to an embodiment of the present application. As shown in FIG. 11 and FIG. 12, the second light emission control subunit 122 includes a third transistor T3, and two terminals of the third transistor T3 are electrically connected to the second terminal of the drive transistor 110a and an anode of the light-emitting element 20, respectively; the pixel circuit 10 also includes an anode reset unit 150, the anode reset unit 150 includes a fifth transistor T5, and two terminals of the fifth transistor T5 are electrically connected to a third potential signal terminal Vref3 and the anode of the light-emitting element 20, respectively; the gate of the third transistor T3 in the pixel circuit 10 connected to an n-th light-emitting element group 30 is configured to receive the second light emission control signal EM2 provided by an n-th stage second shift register unit 510; a gate of the fifth transistor T5 in the pixel circuit 10 connected to the n-th light-emitting element group 30 is configured to receive the second light emission control signal EM2 provided by an (n−i)-th stage second shift register unit 510, where n and i are both positive integers, n≥2, and 1≤i<n; the third transistor T3 and the fifth transistor T5 have different channel types.

In one or more embodiments, the related content of the second light emission control subunit 122, the third transistor T3, the anode reset unit 150, and the fifth transistor T5 may refer to the preceding embodiments and will not be repeated in this embodiment. It should also be noted that to address the problem where a large number of driving signals lead to excessive occupancy of the bezel space, the gate of the third transistor T3 and the gate of the fifth transistor T5 in this embodiment are both configured to receive the second light emission control signal EM2, the gate of the third transistor T3 receives the second light emission control signal EM2 provided by a second shift register unit 510 corresponding to the current stage, and the gate of the fifth transistor T5 receives the second light emission control signal EM2 provided by a second shift register unit 510 corresponding to a preceding stage other than the current stage. That is, the turn-on and turn-off of the third transistor T3 and the fifth transistor T5 can be controlled using the second light emission control signal EM2, and thus it is not required to provide corresponding control signals for both the third transistor T3 and the fifth transistor T5. While the normal operation of the third transistor T3 and the fifth transistor T5 is ensured, the number of driving signals in the pixel circuit 10 is appropriately reduced, the number of signal groups required to drive the pixel circuit 10 is decreased, and peripheral driving bezel space is saved, thereby facilitating a narrow bezel design. Illustratively, n may be 4, and i may be 2. Then, the gate of the third transistor T3 in the pixel circuit 10 connected to a fourth light-emitting element group 30 receives the second light emission control signal EM2 provided by a fourth stage second shift register unit 510, and the gate of the fifth transistor T5 in the pixel circuit 10 connected to the fourth light-emitting element group 30 receives the second light emission control signal EM2 provided by a second stage second shift register unit 510. Of course, i may also be 1 or 3. This embodiment is exemplary and imposes no limitation thereon. Those skilled in the art may make reasonable settings as needed. FIG. 12 illustratively describes that second shift register units 510 at different stages provide the second light emission control signal EM2 to the pixel circuits 10 connected to corresponding light-emitting element groups 30. The display panel may also include first shift register units 410 or other shift register units. Those skilled in the art may select and set positions as needed. FIG. 12 is only exemplary and does not indicate that the display panel includes only second shift register units 510.

Furthermore, in this embodiment, the third transistor T3 and the fifth transistor T5 are configured to have different channel types so that after the third transistor T3 and the fifth transistor T5 receive the corresponding second light emission control signal EM2, they can better adapt to differences in the second light emission control signal EM2 provided by second shift register units 510 at different stages, thereby ensuring that the third transistor T3 and the fifth transistor T5 achieve correct on or off states under corresponding timing conditions. For example, the second light emission control signal EM2 provided by an n-th stage second shift register unit 510 may be a high-level signal, and the second light emission control signal EM2 provided by an (n−i)-th stage second shift register unit 510 may correspondingly be a low-level signal. Then, the third transistor T3 in the pixel circuit 10 connected to an n-th light-emitting element group 30 is turned on under the control of the high-level signal, and the fifth transistor T5 in the pixel circuit 10 connected to the n-th light-emitting element group 30 is turned on under the control of the low-level signal. In this manner, it can be ensured that the third transistor T3 and the fifth transistor T5 are mutually independent and do not affect each other during the control by the second light emission control signal EM2, the compensation function can be achieved, and a higher driving frequency and a higher display image quality are achieved while driving requirements are satisfied.

In one or more embodiments, FIG. 13 is yet another timing graph of a display panel according to an embodiment of the present application. As shown in FIG. 11 and FIG. 13, a driving process of the pixel circuit 10 includes a non-light emission phase S1, the non-light emission phase S1 includes a reset phase S13, and the pixel circuit 10 is also configured such that under the control of the second light emission control signal EM2, the fifth transistor T5 is turned on during at least part of the time of the reset phase S13.

In one or more embodiments, the non-light emission phase S1 includes a reset phase S13. During at least part of the time of the reset phase S13, the fifth transistor T5 may be turned on under the control of the second light emission control signal EM2 so that a reset signal provided by the third potential signal terminal Vref3 can be written to the anode of the light-emitting element 20, thereby resetting the anode of the light-emitting element 20.

In one or more embodiments, with continued reference to FIG. 11 and FIG. 13, the non-light emission phase S1 also includes a threshold compensation phase S11 and a data writing phase S14, and the pixel circuit 10 is also configured such that under the control of the second light emission control signal EM2, the fifth transistor T5 is turned on in the threshold compensation phase S11, and the fifth transistor T5 is turned off in the data writing phase S14.

Illustratively, the non-light emission phase S1 includes a reset phase S13, a threshold compensation phase S11, and a data writing phase S14. In time sequence, the reset phase S13, the threshold compensation phase S11, and the data writing phase S14 are executed sequentially. In the threshold compensation phase S11, the fifth transistor T5 may be turned on under the control of the second light emission control signal EM2 so that a reset signal provided by the third potential signal terminal Vref3 can be written to the second node N2 through the fifth transistor T5 and the third transistor T3, thereby causing the potential at the second terminal of the drive transistor 110a (that is, at the second node N2) to satisfy the condition for subsequently illuminating the light-emitting element 20. In the data writing phase S14, the fifth transistor T5 may be turned off under the control of the second light emission control signal EM2. In this case, the resetting of the anode of the light-emitting element 20 is not required, thereby effectively reducing the power consumption of the display panel.

In one or more embodiments, with continued reference to FIG. 11, FIG. 12, and FIG. 13, the third transistor T3 is an N-type channel transistor, and the fifth transistor T5 is a P-type channel transistor. The control process of the second light emission control signal EM2 will be illustratively described below according to the specific channel types of the third transistor T3 and the fifth transistor T5.

Illustratively, in the reset phase S13, the second light emission control signal EM2 provided by an n-th stage second shift register unit 510 may be a high-level signal, and the second light emission control signal EM2 provided by an (n−i)-th stage second shift register unit 510 may correspondingly be a low-level signal. Then, the gate of the third transistor T3 in the pixel circuit 10 connected to an n-th light-emitting element group 30 receives an active level signal, and the third transistor T3 is correspondingly turned on. The gate of the fifth transistor T5 in the pixel circuit 10 connected to the n-th light-emitting element group 30 receives an active level signal, and the fifth transistor T5 is correspondingly turned on. Thus, a potential signal provided by the third potential signal terminal Vref3 can be written to the anode of the light-emitting element 20 through the fifth transistor T5, and the potential signal provided by the third potential signal terminal Vref3 can be written to the second node N2 through the fifth transistor T5 and the third transistor T3.

In the threshold compensation phase S11, the second light emission control signal EM2 provided by the n-th stage second shift register unit 510 may be a low-level signal, and the second light emission control signal EM2 provided by the (n−i)-th stage second shift register unit 510 may correspondingly be a low-level signal. Then, the gate of the third transistor T3 in the pixel circuit 10 connected to the n-th light-emitting element group 30 receives an inactive level signal, and the third transistor T3 is correspondingly turned off. The gate of the fifth transistor T5 in the pixel circuit 10 connected to the n-th light-emitting element group 30 receives an active level signal, and the fifth transistor T5 is correspondingly turned on. Thus, the potential at the second terminal of the drive transistor 110a (that is, at the second node N2) satisfies the condition for subsequently illuminating the light-emitting element 20.

In the data writing phase S14, the second light emission control signal EM2 provided by the n-th stage second shift register unit 510 may be a high-level signal, and the second light emission control signal EM2 provided by the (n−i)-th stage second shift register unit 510 may correspondingly be a high-level signal. Then, the gate of the third transistor T3 in the pixel circuit 10 connected to the n-th light-emitting element group 30 receives an active level signal, and the third transistor T3 is correspondingly turned on. The gate of the fifth transistor T5 in the pixel circuit 10 connected to the n-th light-emitting element group 30 receives an inactive level signal, and the fifth transistor T5 is correspondingly turned off, thereby further causing the potential at the second terminal of the drive transistor 110a (that is, at the second node N2) to satisfy the condition for subsequently illuminating the light-emitting element 20.

In the light emission phase S2, the second light emission control signal EM2 provided by the n-th stage second shift register unit 510 may be a high-level signal, and the second light emission control signal EM2 provided by the (n−i)-th stage second shift register unit 510 may correspondingly be a high-level signal. Then, the gate of the third transistor T3 in the pixel circuit 10 connected to the n-th light-emitting element group 30 receives an active level signal, and the third transistor T3 is correspondingly turned on. The gate of the fifth transistor T5 in the pixel circuit 10 connected to the n-th light-emitting element group 30 receives an inactive level signal, and the fifth transistor T5 is correspondingly turned off. Thus, a power signal provided by the first power signal terminal PVDD can be transmitted to the drive transistor 110a and the light-emitting element 20 through the first transistor T1, thereby ensuring normal light emission of the light-emitting element 20, and in this case, regulation of the potential at the second node N2 is not required.

In one or more embodiments, with continued reference to FIG. 11, FIG. 12, and FIG. 13, the duration of the reset phase S13 is t1. Among two adjacent stages of second shift register units 510, the second light emission control signal EM2 provided by a later stage second shift register unit 510 is delayed by a preset time Δt relative to the second light emission control signal EM2 provided by a previous stage second shift register unit 510, where 0<Δt≤t1.

Illustratively, in a display or light emission driving scenario, when the display panel needs to progressively complete a reset process from one side to the other side, a delay time Δt exists between the second light emission control signals EM2 of two adjacent stages so that the second light emission control signals EM2 form a scanning timing, thereby ensuring that corresponding light-emitting elements 20 complete the reset process in sequence, avoiding local residual charges or brightness abnormalities, and improving display uniformity. The reset phase S13 is for clearing or initializing the circuit state. In this embodiment, it is configured that Δt≤t1 so that delay of the second light emission control signal EM2 provided by the second shift register unit 510 at a later stage is always limited within the duration of the reset phase S13, thereby ensuring that the turn-on states corresponding to the third transistors T3 and the fifth transistors T5 in the pixel circuits 10 connected to the same light-emitting element group 30 are all completed within the duration of the reset phase S13 and do not overflow to a next working phase (for example, the threshold compensation phase S11 and the data writing phase S14). This configuration avoids functional confusion caused by entering the next working phase before completion of the reset process, thereby ensuring the smoothness and accuracy of working phase switching. FIG. 13 uses Δt=t1 as an example for illustration and description.

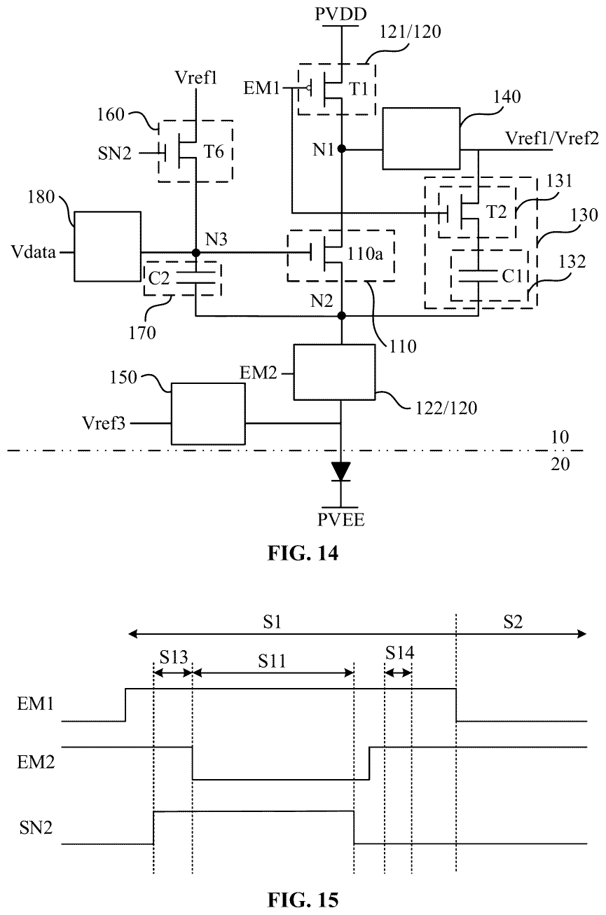

In one or more embodiments, FIG. 14 is yet another diagram illustrating the circuit structure of a display panel according to an embodiment of the present application, and FIG. 15 is yet another timing graph of a display panel according to an embodiment of the present application. As shown in FIG. 14 and FIG. 15, the pixel circuit 10 also includes a reset compensation unit 160 and a second energy storage unit 170; the reset compensation unit 160 is connected between the first potential signal terminal Vref1 and a gate of the drive transistor 110a, and the second energy storage unit 170 is connected between the gate of the drive transistor 110a and the second terminal of the drive transistor 110a; a control terminal of the reset compensation unit 160 is configured to receive a second scan signal SN2. A driving process of the pixel circuit 10 includes a non-light emission phase S1 and a light emission phase S2. The non-light emission phase S1 includes a reset phase S13, a threshold compensation phase S11, and a data writing phase S14. The pixel circuit 10 is also configured such that under the control of the second scan signal SN2, the reset compensation unit 160 is turned on in the reset phase S13 and the threshold compensation phase S11, and the reset compensation unit 160 is turned off in the data writing phase S14 and the light emission phase S2.

In one or more embodiments, the reset compensation unit 160 is connected between the first potential signal terminal Vref1 and the gate of the drive transistor 110a. A connection node between the reset compensation unit 160 and the gate of the drive transistor 110a may be a third node N3. The control terminal of the reset compensation unit 160 receives the second scan signal SN2, thereby enabling the reset compensation unit 160 to be turned on under the control of the second scan signal SN2. Thus, a potential signal provided by the first potential signal terminal Vref1 can be written to the gate of the drive transistor 110a (that is, at the third node N3) through the reset compensation unit 160, thereby resetting the gate of the drive transistor 110a (that is, at the third node N3) and performing threshold compensation. Furthermore, the second energy storage unit 170 is connected between the gate of the drive transistor 110a and the second terminal of the drive transistor 110a, and is used, in combination with the first energy storage unit 130, to regulate the potential at the second node N2, that is, to regulate the potential at a source of the drive transistor 110a.

The driving process of the pixel circuit 10 includes a non-light emission phase S1 and a light emission phase S2, and the non-light emission phase S1 and the light emission phase S2 are executed alternately. The non-light emission phase S1 includes a reset phase S13, a threshold compensation phase S11, and a data writing phase S14. In time sequence, the reset phase S13, the threshold compensation phase S11, and the data writing phase S14 are executed sequentially. In the reset phase S13, the reset compensation unit 160 may be turned on under the control of the second scan signal SN2 so that a potential signal provided by the first potential signal terminal Vref1 can be written to the gate of the drive transistor 110a (that is, at the third node N3) through the reset compensation unit 160, thereby resetting the gate of the drive transistor 110a (that is, at the third node N3). In the threshold compensation phase S11, the reset compensation unit 160 may be turned on under the control of the second scan signal SN2. The third node N3 is equivalent to the gate of the drive transistor 110a, and a threshold voltage Vth is stored through a second capacitor C2 in the second energy storage unit 170. Moreover, the second transistor T2 may be turned on under the control of the first light emission control signal EM1. The second node N2 is equivalent to the source of the drive transistor 110a, and the potential at the second node N2 is regulated through the coupling action of a first capacitor C1 in the first energy storage unit 130 and the coupling action of the second capacitor C2 in the second energy storage unit 170. It should be noted that since the second capacitor C2 in the second energy storage unit 170 stores the threshold voltage Vth at this time, after the second transistor T2 is turned on, part of the threshold voltage Vth in the voltage difference between the second node N2 and the third node N3 can be adaptively canceled through the coupling action of the first capacitor C1 in the first energy storage unit 130 and the coupling action of the second capacitor C2 in the second energy storage unit 170. In this manner, in a subsequent light emission phase S2, the voltage difference between the second node N2 and the third node N3 is independent of the threshold voltage Vth, thereby eliminating the influence of the threshold voltage Vth. Furthermore, in the data writing phase S14 and the light emission phase S2, the reset compensation unit 160 may be turned off under the control of the second scan signal SN2. In this case, resetting of the gate of the drive transistor 110a is not required, thereby effectively reducing the power consumption of the display panel.

In one or more embodiments, with continued reference to FIG. 14, the reset compensation unit 160 includes a sixth transistor T6, and the second energy storage unit 170 includes a second capacitor C2; two terminals of the sixth transistor T6 are electrically connected to the first potential signal terminal Vref1 and the gate of the drive transistor 110a, respectively, and a gate of the sixth transistor T6 receives the second scan signal SN2; a first plate of the second capacitor C2 is electrically connected to the gate of the drive transistor 110a, and a second plate of the second capacitor C2 is electrically connected to the second terminal of the drive transistor 110a.

In one or more embodiments, two terminals of the sixth transistor T6 are electrically connected to the first potential signal terminal Vref1 and the gate of the drive transistor 110a, respectively, and the gate of the sixth transistor T6 receives the second scan signal SN2, thereby enabling the sixth transistor T6 to be turned on under the control of the second scan signal SN2. Thus, a potential signal provided by the first potential signal terminal Vref1 can be written to the gate of the drive transistor 110a (that is, at the third node N3) through the sixth transistor T6, thereby resetting the gate of the drive transistor 110a (that is, at the third node N3) and performing threshold compensation. The first plate of the second capacitor C2 is electrically connected to the gate of the drive transistor 110a, and the second plate of the second capacitor C2 is electrically connected to the second terminal of the drive transistor 110a. The second capacitor C2 can store the threshold voltage Vth, and the second capacitor C2 is combined with the first capacitor C1 to regulate the potential at the second terminal of the drive transistor 110a (that is, at the second node N2).

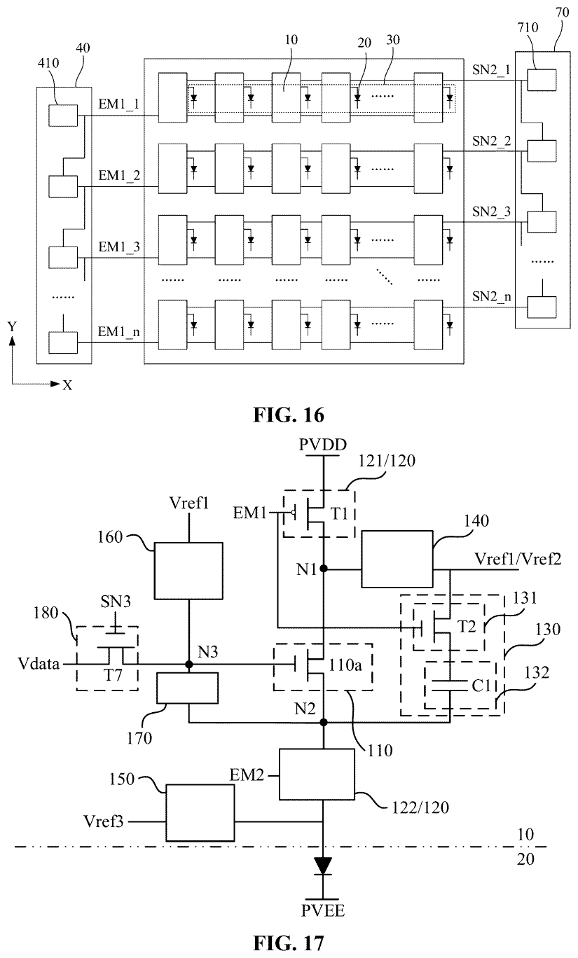

In one or more embodiments, FIG. 16 is yet another diagram illustrating the overall structure of a display panel according to an embodiment of the present application. As shown in FIG. 16, multiple light-emitting elements 20 are arranged in an array along a first direction X and a second direction Y; multiple light-emitting elements 20 arranged along the first direction X form a light-emitting element group 30, and multiple light-emitting element groups 30 are arranged along the second direction Y; the display panel also includes a fourth shift register circuit 70, and the fourth shift register circuit 70 includes multiple cascaded fourth second register units 710; a fourth shift register unit 710 is configured to output the second scan signal SN2 to the pixel circuits 10 connected to the same light-emitting element group 30.

In one or more embodiments, the display panel also includes a fourth shift register circuit 70, and the fourth shift register circuit 70 includes multiple cascaded fourth shift register units 710. Each fourth shift register unit 710 corresponds to one light-emitting element group 30, and each fourth shift register unit 710 outputs the same second scan signal SN2 to the pixel circuits 10 connected to all light-emitting elements 20 in the corresponding light-emitting element group 30. That is, the fourth shift register circuit 70 provides a uniform second scan signal SN2 to a group of light-emitting elements 20 in the same row or the same column through the cascaded fourth shift register units 710.

It should also be noted that the display panel shown in FIG. 16 includes both a first shift register circuit 40 and a fourth shift register circuit 70. The relative positions of the first shift register circuit 40 and the fourth shift register circuit 70 are exemplary, and no limitation is imposed thereon. Illustratively, the first shift register circuit 40 and the fourth shift register circuit 70 may be located on the same side of each light-emitting element group 30 (for example, both on a left side or both on a right side). The first shift register circuit 40 and the fourth shift register circuit 70 may also be located on two opposite sides of each light-emitting element group 30 (for example, one on the left and one on the right, or one on the top and one on the bottom). The first shift register circuit 40 and the fourth shift register circuit 70 may also be located on two adjacent sides of each light-emitting element group 30 (for example, one on the left and one on the top, or one on the right and one on the bottom). Those skilled in the art may make reasonable settings as needed. In addition, the display panel may include any one of a first shift register circuit 40, a second shift register circuit 50, a third shift register circuit 60, and a fourth shift register circuit 70. The display panel may also simultaneously include a first shift register circuit 40, a second shift register circuit 50, a third shift register circuit 60, and a fourth shift register circuit 70. The specific positional relationships among the four may be reasonably set as needed, which is not illustrated one by one in this embodiment.

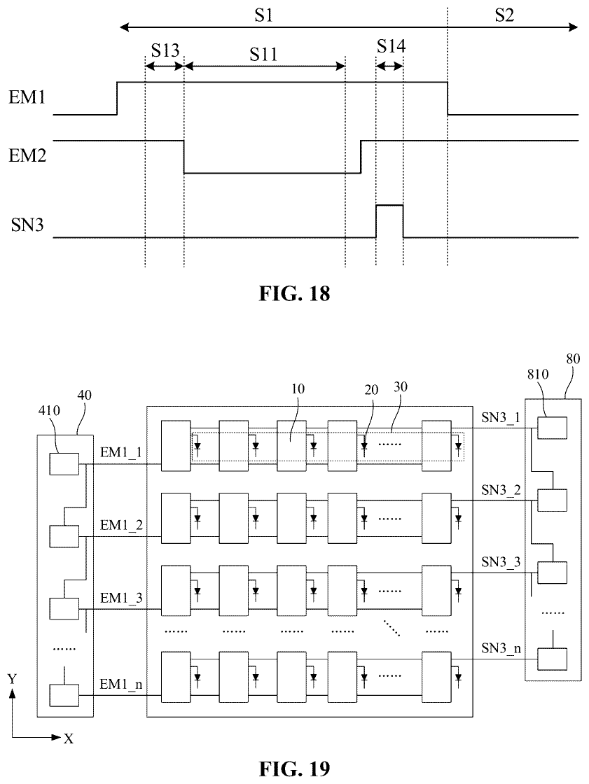

In one or more embodiments, FIG. 17 is yet another diagram illustrating the circuit structure of a display panel according to an embodiment of the present application, and FIG. 18 is yet another timing graph of a display panel according to an embodiment of the present application. As shown in FIG. 17 and FIG. 18, the pixel circuit 10 also includes a data writing unit 180, and the data writing unit 180 is connected between a data signal terminal Vdata and a gate of the drive transistor 110a; a control terminal of the data writing unit 180 is configured to receive a third scan signal SN3. A driving process of the pixel circuit 10 includes a non-light emission phase S1. The non-light emission phase S1 includes a data writing phase S14. The pixel circuit 10 is also configured such that under the control of the third scan signal SN3, the data writing unit 180 is turned on in the data writing phase S14.

In one or more embodiments, the data writing unit 180 is connected between the data signal terminal Vdata and the gate of the drive transistor 110a. A connection node between the data writing unit 180 and the gate of the drive transistor 110a may be a third node N3. A control terminal of the data writing unit 180 receives the third scan signal SN3, thereby enabling the data writing unit 180 to be turned on under the control of the third scan signal SN3. Thus, a data signal provided by the data signal terminal Vdata can be written to the gate of the drive transistor 110a (that is, at the third node N3) through the data writing unit 180, thereby performing data writing on the gate of the drive transistor 110a (that is, at the third node N3).

The driving process of the pixel circuit 10 includes a non-light emission phase S1, and the non-light emission phase S1 includes a data writing phase S14. In the data writing phase S14, the data writing unit 180 may be turned on under the control of the third scan signal SN3 so that a data signal provided by the data signal terminal Vdata can be written to the gate of the drive transistor 110a (that is, at the third node N3) through the data writing unit 180, thereby completing a data writing process to the gate of the drive transistor 110a (that is, at the third node N3).

In one or more embodiments, with continued reference to FIG. 17, the data writing unit 180 includes a seventh transistor T7, two terminals of the seventh transistor T7 are connected to the data signal terminal Vdata and the gate of the drive transistor 110a, respectively, and a gate of the seventh transistor T7 is configured to receive the third scan signal SN3.

In one or more embodiments, two terminals of the seventh transistor T7 are connected to the data signal terminal Vdata and the gate of the drive transistor 110a, respectively, and the gate of the seventh transistor T7 receives the third scan signal SN3, thereby enabling the seventh transistor T7 to be turned on under the control of the third scan signal SN3. Thus, a data signal provided by the data signal terminal Vdata can be written to the gate of the drive transistor 110a (that is, at the third node N3) through the data writing unit 180, thereby performing data writing on the gate of the drive transistor 110a (that is, at the third node N3).

In one or more embodiments, FIG. 19 is yet another diagram illustrating the overall structure of a display panel according to an embodiment of the present application. As shown in FIG. 19, multiple light-emitting elements 20 are arranged in an array along a first direction X and a second direction Y; multiple light-emitting elements 20 arranged along the first direction X form a light-emitting element group 30, and multiple light-emitting element groups 30 are arranged along the second direction Y; the display panel also includes a fifth shift register circuit 80, and the fifth shift register circuit 80 includes multiple cascaded fifth second register units 810; a fifth shift register unit 810 is configured to output the third scan signal SN3 to the pixel circuits 10 connected to the same light-emitting element group 30.

Illustratively, the display panel also includes a fifth shift register circuit 80, and the fifth shift register circuit 80 includes multiple cascaded fifth shift register units 810. Each fifth shift register unit 810 corresponds to one light-emitting element group 30, and each fifth shift register unit 810 outputs the same third scan signal SN3 to the pixel circuits 10 connected to all light-emitting elements 20 in the corresponding light-emitting element group 30. That is, the fifth shift register circuit 80 provides a uniform third scan signal SN3 to a group of light-emitting elements 20 in the same row or the same column through the cascaded fifth shift register units 810.

It should also be noted that the display panel shown in FIG. 19 includes both a first shift register circuit 40 and a fifth shift register circuit 80. The relative positions of the first shift register circuit 40 and the fifth shift register circuit 80 are exemplary, and no limitation is imposed thereon. Illustratively, the first shift register circuit 40 and the fifth shift register circuit 80 may be located on the same side of each light-emitting element group 30 (for example, both on a left side or both on a right side). The first shift register circuit 40 and the fifth shift register circuit 80 may also be located on two opposite sides of each light-emitting element group 30 (for example, one on the left and one on the right, or one on the top and one on the bottom). The first shift register circuit 40 and the fifth shift register circuit 80 may also be located on two adjacent sides of each light-emitting element group 30 (for example, one on the left and one on the top, or one on the right and one on the bottom). Those skilled in the art may make reasonable settings as needed. In addition, the display panel may include any one of a first shift register circuit 40, a second shift register circuit 50, a third shift register circuit 60, a fourth shift register circuit 70, and a fifth shift register circuit 80. The display panel may also simultaneously include a first shift register circuit 40, a second shift register circuit 50, a third shift register circuit 60, a fourth shift register circuit 70, and a fifth shift register circuit 80. The specific positional relationships among the five may be reasonably set as needed, which is not illustrated one by one in this embodiment. Exemplarily, in a specific embodiment, the first shift register circuit 40 and the second shift register circuit 50 may both be located on one side of the display panel (for example, a left side), and the third shift register circuit 60, the fourth shift register circuit 70, and the fifth shift register circuit 80 may be located on the remaining three sides of the display panel, respectively (for example, a right side, a top side, and a bottom side).

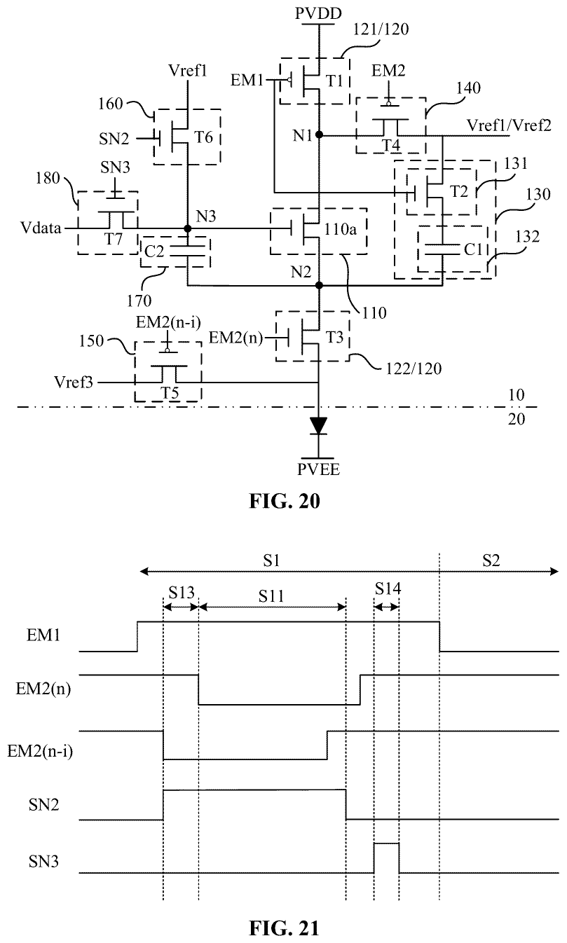

Based on the preceding embodiments, in yet another specific embodiment, FIG. 20 is yet another diagram illustrating the circuit structure of a display panel according to an embodiment of the present application, and FIG. 21 is yet another timing graph of a display panel according to an embodiment of the present application. As shown in FIG. 20 and FIG. 21, the display panel includes a pixel circuit 10 and a light-emitting element 20. A driving process of the pixel circuit 10 includes a non-light emission phase S1 and a light emission phase S2, and the non-light emission phase S1 includes a reset phase S13, a threshold compensation phase S11, and a data writing phase S14. The pixel circuit 10 may be understood as an 8T2C circuit, where a first transistor T1, a fourth transistor T4, and a fifth transistor T5 are all P-type channel transistors, and a second transistor T2, a third transistor T3, a sixth transistor T6, a seventh transistor T7, and a drive transistor 110a are all N-type channel transistors. Furthermore, a first terminal of the drive transistor 110a corresponds to a first node N1, a second terminal of the drive transistor 110a corresponds to a second node N2, and a gate/control terminal of the drive transistor 110a corresponds to a third node N3. A gate of the first transistor T1 and a gate of the second transistor T2 both receive the same first light emission control signal EM1. A gate of the third transistor T3 and a gate of the fourth transistor T4 both receive the same second light emission control signal EM2. A gate of the fifth transistor T5 also receives the second light emission control signal EM2. Illustratively, the gate of the third transistor T3 and the gate of the fourth transistor T4 correspondingly receive the second light emission control signal EM2 provided by an n-th stage second shift register unit 510, while the gate of the fifth transistor T5 correspondingly receives the second light emission control signal EM2 provided by an (n−i)-th stage second shift register unit 510. A gate of the sixth transistor T6 receives a second scan signal SN2, and a gate of the seventh transistor T7 receives a third scan signal SN3. In this manner, the pixel circuit 10 in this embodiment includes four gate driving signals, thereby decreasing the number of signal groups required to drive the pixel circuit 10, correspondingly reducing the number of shift registers used, saving peripheral driving bezel space, and facilitating a narrow bezel design. A specific driving process of the pixel circuit 10 may refer to the following content:

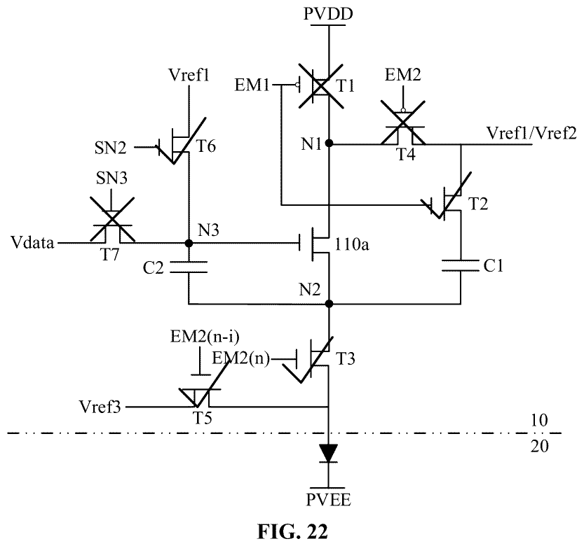

FIG. 22 is a diagram illustrating the structure of the display panel shown in FIG. 20 during a reset phase. As shown in FIG. 20 and FIG. 22, in the reset phase S13, the first transistor T1 is turned off under the control of the first light emission control signal EM1, the fourth transistor T4 is turned off under the control of the second light emission control signal EM2, the sixth transistor T6 is turned on under the control of the second scan signal SN2, and the seventh transistor T7 is turned off under the control of the third scan signal SN3. Then, the potential at the third node N3 is reset to Vref1, that is, V(N3)=Vref1. Furthermore, the second transistor T2 is turned on under the control of the first light emission control signal EM1, the third transistor T3 is turned on under the control of the second light emission control signal EM2, and the fifth transistor T5 is also turned on under the control of the second light emission control signal EM2. Then, the anode voltage of the light-emitting element 20 is reset to Vref3, and the potential at the second node N2 is also reset to Vref3, that is, V(N2)=Vref3.

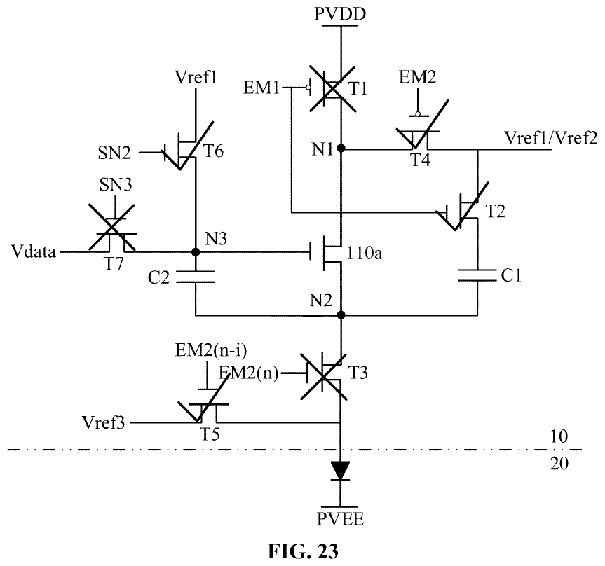

FIG. 23 is a diagram illustrating the structure of the display panel shown in FIG. 20 during a threshold compensation phase. As shown in FIG. 20 and FIG. 23, in the threshold compensation phase S11, the fourth transistor T4 is turned on under the control of the second light emission control signal EM2 so that a potential signal provided by the first potential signal terminal Vref1 is written to the first node N1. Then, the potential at the first node N1 is written as Vref1, that is, V(N1)=Vref1. The second transistor T2 is turned on under the control of the first light emission control signal EM1, and the voltage is stored through the first capacitor C1. The first transistor T1 is turned off under the control of the first light emission control signal EM1, the third transistor T3 is turned off under the control of the second light emission control signal EM2, the fifth transistor T5 is also turned on under the control of the second light emission control signal EM2, the seventh transistor T7 is turned off under the control of the third scan signal SN3, and the sixth transistor T6 is turned on under the control of the second scan signal SN2. Then, the potential at the third node N3 is also written as Vref1, that is, V(N3)=Vref1. In this case, the potential Vref1 at the third node N3 is greater than the potential Vref3 at the second node N2 in the preceding reset phase S13, causing the drive transistor 110a to be turned on, and the potential at the second node N2 is regulated through the coupling action of the first capacitor C1 and the coupling action of the second capacitor C2. That is, in the threshold compensation phase S11, the potential at the second node N2 is progressively coupled to Vref1−Vth, where Vth may be understood as a preset threshold voltage. In this case, the potential difference of the first capacitor C1 is Vth, which may be understood as the first capacitor C1 storing the threshold voltage Vth. The capacitance value of the first capacitor C1 is L1, and a charge amount Q1 of the first capacitor C1 satisfies that Q1=L1×Vth. Furthermore, the potential difference of the second capacitor C2 is also Vth, which may be understood as the second capacitor C2 storing the threshold voltage Vth. The capacitance value of the second capacitor C2 is L2, and a charge amount Q2 of the second capacitor C2 satisfies that Q2=L2×Vth.

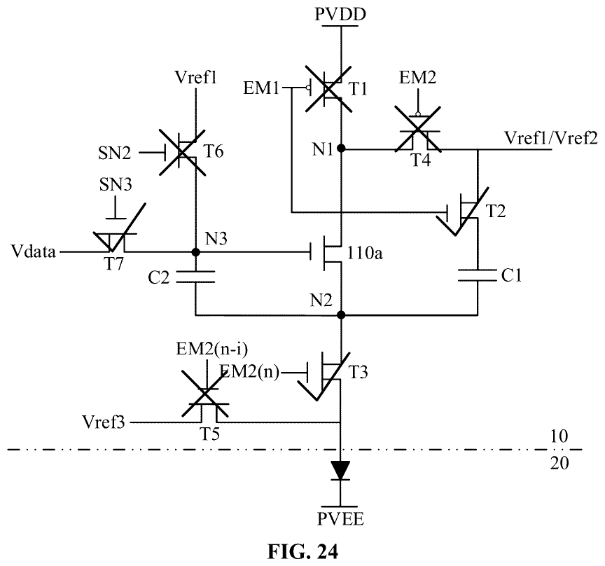

FIG. 24 is a diagram illustrating the structure of the display panel shown in FIG. 20 during a data writing phase. As shown in FIG. 20 and FIG. 24, in the data writing phase S14, the sixth transistor T6 is turned off under the control of the second scan signal SN2, and the seventh transistor T7 is turned on under the control of the third scan signal SN3. Then, the potential at the third node N3 changes from Vref1 to Vdata, that is, the potential at the third node N3 is written as Vdata. The second transistor T2 is turned on under the control of the first light emission control signal EM1, and the voltage is stored through the first capacitor C1. The first transistor T1 is turned off under the control of the first light emission control signal EM1, the third transistor T3 is turned on under the control of the second light emission control signal EM2, the fourth transistor T4 is turned off under the control of the second light emission control signal EM2, and the fifth transistor T5 is also turned off the under the control of the second light emission control signal EM2. In this case, the potential V(N2) at the second node N2 also changes. In this case, a charge amount Q1′ of the first capacitor C1 satisfies that Q1′=L1×[Vref1−V(N2)], and a charge amount Q2′ of the second capacitor C2 satisfies that Q2′=L2×[Vdata−V(N2)]. Based on the law of conservation of capacitor charge, that Q1+Q2=Q1′+Q2′ exists, that is, L1×Vth+L2×Vth=L1×[Vref1−V(N2)]+L2×[Vdata−V(N2)]. Then, the following is derived: V(N2)=(L1×Vref1+L2×Vdata)/(L1+L2)−Vth, and further V(N2)=Vref1+[L2×(Vdata-Vref1)/(L1+L2)]-Vth. In this manner, the potential V(N2) at the second node N2 can be obtained. The potential V(N2) at the second node N2 is a source voltage of the drive transistor 110a, and the potential V(N3) at the third node N3 is a gate voltage of the drive transistor 110a. Then, a gate-source voltage Vgs of the drive transistor 110a can be obtained as satisfying that Vgs=V(N3)−V(N2)=Vdata−Vref1−[L2×(Vdata−Vref1)/(L1+L2)]+Vth. After simplification, the following can be obtained: Vgs=L1×(Vdata−Vref1)/(L1+L2)+Vth.

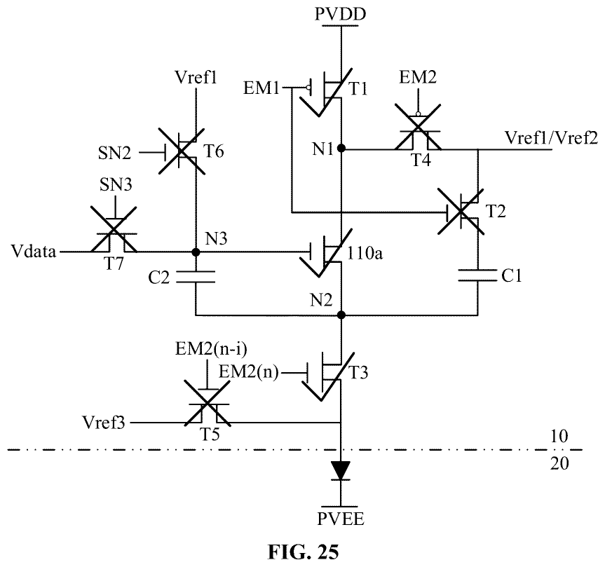

FIG. 25 is a diagram illustrating the structure of the display panel shown in FIG. 20 during a light emission phase. As shown in FIG. 20 and FIG. 25, in the light emission phase S2, a formula of a light emission current that Id=k×(Vgs−Vth)\hat{ }2=k×[(Vdata−Vref1)/(L1+L2)]\hat{ }2 is referred to, where Id is the light emission current, and k is a light emission constant. That is, the influence of the threshold voltage Vth is eliminated through the coupling action of the first capacitor C1 and the coupling action of the second capacitor C2.

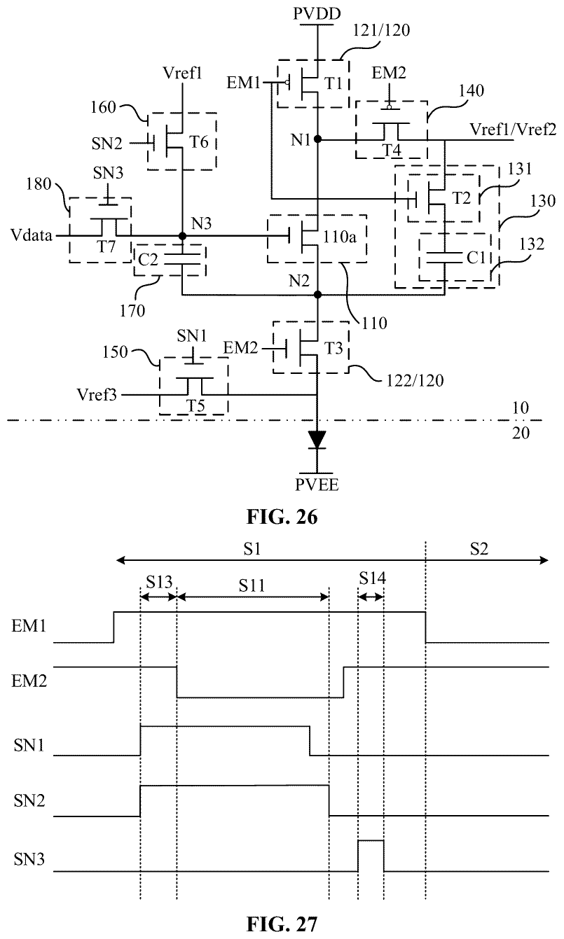

Based on the preceding embodiments, in yet another specific embodiment, FIG. 26 is yet another diagram illustrating the circuit structure of a display panel according to an embodiment of the present application, and FIG. 27 is yet another timing graph of a display panel according to an embodiment of the present application. As shown in FIG. 26 and FIG. 27, the display panel includes a pixel circuit 10 and a light-emitting element 20. A driving process of the pixel circuit 10 includes a non-light emission phase S1 and a light emission phase S2, and the non-light emission phase S1 includes a reset phase S13, a threshold compensation phase S11, and a data writing phase S14. The pixel circuit 10 may be understood as an 8T2C circuit, where a first transistor T1 and a fourth transistor T4 are both P-type channel transistors, and a second transistor T2, a third transistor T3, a fifth transistor T5, a sixth transistor T6, a seventh transistor T7, and a drive transistor 110a are all N-type channel transistors. Furthermore, a first terminal of the drive transistor 110a corresponds to a first node N1, a second terminal of the drive transistor 110a corresponds to a second node N2, and a gate/control terminal of the drive transistor 110a corresponds to a third node N3. A gate of the first transistor T1 and a gate of the second transistor T2 both receive the same first light emission control signal EM1. A gate of the third transistor T3 and a gate of the fourth transistor T4 both receive the same second light emission control signal EM2. A gate of the fifth transistor T5 receives a first scan signal SN1. A gate of the sixth transistor T6 receives a second scan signal SN2. A gate of the seventh transistor T7 receives a third scan signal SN3. In this manner, the pixel circuit 10 in this embodiment includes five gate driving signals, thereby decreasing the number of signal groups required to drive the pixel circuit 10, correspondingly reducing the number of shift registers used, saving peripheral driving bezel space, and facilitating a narrow bezel design. A specific driving process of the pixel circuit 10 may refer to FIG. 22 to FIG. 25, and will not be repeated in this embodiment.

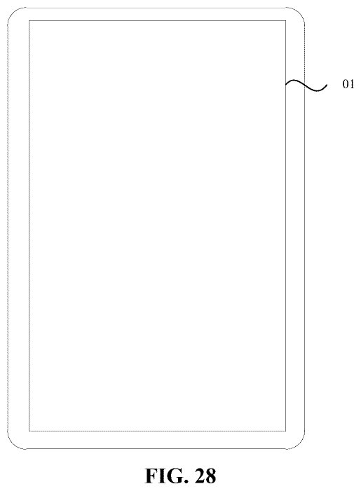

Based on the same concept, embodiments of the present application also provide a display device. FIG. 28 is a diagram illustrating the structure of a display device according to an embodiment of the present application. As shown in FIG. 28, the display device includes the display panel 01 in the preceding embodiments. The display device includes the display panel 01 described in any embodiment of the present application. Therefore, the display device provided by this embodiment of the present application has the corresponding beneficial effects of the display panel 01 provided by the embodiments of the present application. The beneficial effects are not repeated here. Exemplarily, the display device may be an electronic device such as a mobile phone, a computer, a smart wearable device (for example, a smart watch), or an in-vehicle display device, which is not limited in the embodiments of the present application.

Embodiments of the present application provide a display panel and a display device. The display panel includes multiple pixel circuits and multiple light-emitting elements. A pixel circuit includes a drive unit, a light emission control unit, and a first energy storage unit. The light emission control unit includes a first light emission control subunit and a second light emission control subunit. The drive unit includes a drive transistor. The first light emission control subunit, the drive transistor, the second light emission control subunit, and a light-emitting element are sequentially connected in series between a first power signal terminal and a second power signal terminal. The first light emission control subunit is electrically connected to a first terminal of the drive transistor, and the first energy storage unit is connected between a first potential signal terminal and a second terminal of the drive transistor. The first light emission control subunit includes a first transistor. The first energy storage unit includes an energy storage control subunit, and the energy storage control subunit includes a second transistor. A gate of the first transistor and a gate of the second transistor both receive the same first light emission control signal. The first transistor and the second transistor have different channel types. In the display panel, a gate of a first transistor in the first light emission control subunit and a gate of a second transistor in the first energy storage unit both receive the same first light emission control signal. That is, transistors and gate control signals do not need to be arranged in a one-to-one correspondence. With this configuration, while the compensation function is achieved, the number of driving signals in the pixel circuits is appropriately reduced, the number of signal groups required to drive the pixel circuits is decreased, and the number of corresponding shift registers used is correspondingly reduced, thereby saving peripheral driving bezel space, facilitating a narrow bezel design, and satisfying driving requirements while achieving a higher driving frequency and a higher display image quality. Furthermore, since the first transistor and the second transistor have different channel types, after the gates of the first transistor and the second transistor receive the corresponding first light emission control signal, their turn-on or turn-off states are opposite. That is, the driving signal control processes for the first transistor and the second transistor are mutually independent and do not affect each other, thereby improving the situation in current pixel circuits where structures are relatively complex and occupy more bezel space, and reducing the complexity of the driving method for the pixel circuits.

It is to be understood that various forms of processes shown above may be adopted with steps reordered, added, or deleted. For example, the steps described in the present application may be performed in parallel, sequentially, or in different orders, as long as the desired results of the technical solutions of the present application can be achieved, and no limitation is imposed herein.

The preceding embodiments do not limit the scope of the present application. It is to be understood by those skilled in the art that various modifications, combinations, sub-combinations, and substitutions may be performed according to design requirements and other factors. Any modifications, equivalent substitutions, improvements, and the like made within the spirit and principle of the present application are within the scope of the present application.

What is claimed is:

1. A display panel, comprising a plurality of pixel circuits and a plurality of light-emitting elements;
wherein a pixel circuit of the plurality of pixel circuits comprises a drive unit, a light emission control unit, and a first energy storage unit;
the light emission control unit comprises a first light emission control subunit and a second light emission control subunit, the drive unit comprises a drive transistor, and the first light emission control subunit, the drive transistor, the second light emission control subunit, and a light-emitting element of the plurality of light-emitting elements are sequentially connected in series between a first power signal terminal and a second power signal terminal;
the first light emission control subunit is electrically connected to a first terminal of the drive transistor, and the first energy storage unit is connected between a first potential signal terminal and a second terminal of the drive transistor;
the first light emission control subunit comprises a first transistor, the first energy storage unit comprises an energy storage control subunit, and the energy storage control subunit comprises a second transistor; and
a gate of the first transistor and a gate of the second transistor are configured to receive a same first light emission control signal, and the first transistor and the second transistor have different channel types.

2. The display panel according to claim 1, wherein a driving process of the pixel circuit comprises a non-light emission phase and a light emission phase, and the pixel circuit is configured such that:
under control of the first light emission control signal, the first transistor is turned off and the second transistor is turned on in the non-light emission phase, and the first transistor is turned on and the second transistor is turned off in the light emission phase.

3. The display panel according to claim 1, wherein two terminals of the first transistor are electrically connected to the first power signal terminal and the first terminal of the drive transistor, respectively, the first energy storage unit further comprises an energy storage subunit, and the energy storage subunit comprises a first capacitor; and
wherein the energy storage control subunit and the energy storage subunit are sequentially connected in series between the first potential signal terminal and the second terminal of the drive transistor, and a first terminal of the second transistor is electrically connected to the first potential signal terminal, a second terminal of the second transistor is electrically connected to a first plate of the first capacitor, and a second plate of the first capacitor is electrically connected to the second terminal of the drive transistor; or
wherein the energy storage control subunit and the energy storage subunit are sequentially connected in series between the second terminal of the drive transistor and the first potential signal terminal, and a first terminal of the second transistor is electrically connected to the second terminal of the drive transistor, a second terminal of the second transistor is electrically connected to a first plate of the first capacitor, and a second plate of the first capacitor is electrically connected to the first potential signal terminal.

4. The display panel according to claim 1, wherein the first transistor is a P-type channel transistor, and the second transistor is an N-type channel transistor.

5. The display panel according to claim 1, wherein the plurality of light-emitting elements are arranged in an array along a first direction and a second direction, a plurality of light-emitting elements arranged along the first direction form a light-emitting element group, and a plurality of light-emitting element groups are arranged along the second direction;
the display panel further comprises a first shift register circuit, and the first shift register circuit comprises a plurality of cascaded first shift register units; and
a first shift register unit of the plurality of cascaded first shift register units is configured to output the first light emission control signal to pixel circuits connected to a same light-emitting element group.

6. The display panel according to claim 1, wherein the second light emission control subunit comprises a third transistor, and two terminals of the third transistor are electrically connected to the second terminal of the drive transistor and an anode of the light-emitting element, respectively;
the pixel circuit further comprises a compensation control unit, the compensation control unit comprises a fourth transistor, and two terminals of the fourth transistor are electrically connected to a second potential signal terminal and the first terminal of the drive transistor respectively; and
a gate of the third transistor and a gate of the fourth transistor are configured to receive a same second light emission control signal, and the third transistor and the fourth transistor have different channel types.

7. The display panel according to claim 6, wherein a driving process of the pixel circuit comprises a non-light emission phase and a light emission phase, the non-light emission phase comprises a threshold compensation phase, and the pixel circuit is further configured such that:
under control of the second light emission control signal, the fourth transistor is turned on and the third transistor is turned off in the threshold compensation phase, and the fourth transistor is turned off and the third transistor is turned on in the light emission phase; and
wherein the non-light emission phase further comprises a non-threshold compensation phase, and the pixel circuit is further configured such that:
under control of the second light emission control signal, the fourth transistor is turned off and the third transistor is turned on in the non-threshold compensation phase.

8. The display panel according to claim 6, wherein at least one of the following configurations is satisfied:
the third transistor is an N-type channel transistor, the fourth transistor is a P-type channel transistor, and the drive transistor is an N-type channel transistor;
the first potential signal terminal or the first power signal terminal is reused as the second potential signal terminal; and
the plurality of light-emitting elements are arranged in an array along a first direction and a second direction, a plurality of light-emitting elements arranged along the first direction form a light-emitting element group, and a plurality of light-emitting element groups are arranged along the second direction; the display panel further comprises a second shift register circuit, and the second shift register circuit comprises a plurality of cascaded second shift register units; and a second shift register unit of the plurality of cascaded second shift register units is configured to output the second light emission control signal to pixel circuits connected to a same light-emitting element group.

9. The display panel according to claim 1, wherein the second light emission control subunit comprises a third transistor, and two terminals of the third transistor are electrically connected to the second terminal of the drive transistor and an anode of the light-emitting element, respectively;
the pixel circuit further comprises an anode reset unit, the anode reset unit comprises a fifth transistor, and two terminals of the fifth transistor are electrically connected to a third potential signal terminal and the anode of the light-emitting element, respectively; and
a gate of the third transistor is configured to receive a second light emission control signal, a gate of the fifth transistor is configured to receive a first scan signal, and the third transistor and the fifth transistor have a same channel type.

10. The display panel according to claim 9, wherein a driving process of the pixel circuit comprises a non-light emission phase and a light emission phase, the non-light emission phase comprises a reset phase, and the pixel circuit is further configured such that:
under control of the first scan signal, the fifth transistor is turned on in the reset phase, and the fifth transistor is turned off in the light emission phase; and
wherein the non-light emission phase further comprises a threshold compensation phase and a data writing phase, and the pixel circuit is further configured such that:
under control of the first scan signal, the fifth transistor is turned on in the threshold compensation phase, and the fifth transistor is turned off in the data writing phase.

11. The display panel according to claim 9, wherein at least one of the following configurations is satisfied:
the third transistor and the fifth transistor are both N-type channel transistors; and
the plurality of light-emitting elements are arranged in an array along a first direction and a second direction, a plurality of light-emitting elements arranged along the first direction form a light-emitting element group, and a plurality of light-emitting element groups are arranged along the second direction; the display panel further comprises a third shift register circuit, and the third shift register circuit comprises a plurality of cascaded third shift register units; and a third shift register unit of the plurality of cascaded third shift register units is configured to output the first scan signal to pixel circuits connected to a same light-emitting element group.

12. The display panel according to claim 8, wherein the pixel circuit further comprises an anode reset unit, the anode reset unit comprises a fifth transistor, and two terminals of the fifth transistor are electrically connected to a third potential signal terminal and the anode of the light-emitting element, respectively;
the gate of the third transistor in the pixel circuit connected to an n-th light-emitting element group is configured to receive the second light emission control signal provided by an n-th stage second shift register unit of the plurality of cascaded third shift register units;
a gate of the fifth transistor in the pixel circuit connected to the n-th light-emitting element group is configured to receive the second light emission control signal provided by an (n−i)-th stage second shift register unit of the plurality of cascaded third shift register units;
wherein n and i are both positive integers, n≥2, and 1≤i<n; and
the third transistor and the fifth transistor have different channel types.

13. The display panel according to claim 12, wherein a driving process of the pixel circuit comprises a non-light emission phase, the non-light emission phase comprises a reset phase, and the pixel circuit is further configured such that:
under control of the second light emission control signal, the fifth transistor is turned on during at least part of time of the reset phase; and
wherein the non-light emission phase further comprises a threshold compensation phase and a data writing phase, and the pixel circuit is further configured such that:
under control of the second light emission control signal, the fifth transistor is turned on in the threshold compensation phase, and the fifth transistor is turned off in the data writing phase.

14. The display panel according to claim 13, wherein a duration of the reset phase is t1, and among two adjacent stages of second shift register units, a second light emission control signal provided by a later stage second shift register unit is delayed by a preset time Δt relative to a second light emission control signal provided by a previous stage second shift register unit;
wherein 0<Δt≤t1.

15. The display panel according to claim 12, wherein the third transistor is an N-type channel transistor, and the fifth transistor is a P-type channel transistor.

16. The display panel according to claim 1, wherein the pixel circuit further comprises a reset compensation unit and a second energy storage unit;
the reset compensation unit is connected between the first potential signal terminal and a gate of the drive transistor, the second energy storage unit is connected between the gate of the drive transistor and the second terminal of the drive transistor, and a control terminal of the reset compensation unit is configured to receive a second scan signal; and
a driving process of the pixel circuit comprises a non-light emission phase and a light emission phase, the non-light emission phase comprises a reset phase, a threshold compensation phase, and a data writing phase, and the pixel circuit is further configured such that:
under control of the second scan signal, the reset compensation unit is turned on in the reset phase and the threshold compensation phase, and the reset compensation unit is turned off in the data writing phase and the light emission phase.

17. The display panel according to claim 16, wherein at least one of the following configurations is satisfied:
the reset compensation unit comprises a sixth transistor, and the second energy storage unit comprises a second capacitor; two terminals of the sixth transistor are electrically connected to the first potential signal terminal and the gate of the drive transistor, respectively, and a gate of the sixth transistor is configured to receive the second scan signal; and a first plate of the second capacitor is electrically connected to the gate of the drive transistor, and a second plate of the second capacitor is electrically connected to the second terminal of the drive transistor; and
the plurality of light-emitting elements are arranged in an array along a first direction and a second direction, a plurality of light-emitting elements arranged along the first direction form a light-emitting element group, and a plurality of light-emitting element groups are arranged along the second direction; the display panel further comprises a fourth shift register circuit, and the fourth shift register circuit comprises a plurality of cascaded fourth shift register units; and a fourth shift register unit of the plurality of cascaded fourth shift register units is configured to output the second scan signal to pixel circuits connected to a same light-emitting element group.

18. The display panel according to claim 1, wherein the pixel circuit further comprises a data writing unit, the data writing unit is connected between a data signal terminal and a gate of the drive transistor, and a control terminal of the data writing unit is configured to receive a third scan signal; and
a driving process of the pixel circuit comprises a non-light emission phase, the non-light emission phase comprises a data writing phase, and the pixel circuit is further configured such that:
under control of the third scan signal, the data writing unit is turned on in the data writing phase.

19. The display panel according to claim 18, wherein at least one of the following configurations is satisfied:
the data writing unit comprises a seventh transistor, two terminals of the seventh transistor are connected to the data signal terminal and the gate of the drive transistor, respectively, and a gate of the seventh transistor is configured to receive the third scan signal; and
the plurality of light-emitting elements are arranged in an array along a first direction and a second direction, a plurality of light-emitting elements arranged along the first direction form a light-emitting element group, and a plurality of light-emitting element groups are arranged along the second direction; the display panel further comprises a fifth shift register circuit, and the fifth shift register circuit comprises a plurality of cascaded fifth shift register units; and a fifth shift register unit of the plurality of cascaded fifth shift register units is configured to output the third scan signal to pixel circuits connected to a same light-emitting element group.

20. A display device, comprising a display panel comprising a plurality of pixel circuits and a plurality of light-emitting elements;
wherein a pixel circuit of the plurality of pixel circuits comprises a drive unit, a light emission control unit, and a first energy storage unit;
the light emission control unit comprises a first light emission control subunit and a second light emission control subunit, the drive unit comprises a drive transistor, and the first light emission control subunit, the drive transistor, the second light emission control subunit, and a light-emitting element of the plurality of light-emitting elements are sequentially connected in series between a first power signal terminal and a second power signal terminal;
the first light emission control subunit is electrically connected to a first terminal of the drive transistor, and the first energy storage unit is connected between a first potential signal terminal and a second terminal of the drive transistor;
the first light emission control subunit comprises a first transistor, the first energy storage unit comprises an energy storage control subunit, and the energy storage control subunit comprises a second transistor; and
a gate of the first transistor and a gate of the second transistor are configured to receive a same first light emission control signal, and the first transistor and the second transistor have different channel types.
